(19) United States
(12) Patent Application Publication
(10) Pub. No.: US 2008/0140514 A1
(43) Pub. Date: Jun. 12, 2008

(54) Method and system for risk evaluation and management

(75) Inventor: Peter Stenger, Pleasant Ridge, MI (US)

Correspondence Address: COHEN & GRIGSBY, P.C., 11 STANWIX STREET, 15TH FLOOR, PITTSBURGH, PA, 15222, US

(73) Assignee: Grant Thornton LLP, Chigaco, IL (US)

(21) Appl. No.: 12/001,287

(22) Filed: Dec. 11, 2007

Related U.S. Application Data
(60) Provisional application No. 60/874,154, filed on Dec. 11, 2006.

(51) Int. Cl. G06Q 40/00; G06F 17/30

(52) U.S. Cl. 705/10; 705/36 R

(57) ABSTRACT

A method and system for assessing the risk that an entity (50) will not meet performance expectations wherein dependencies (52, 54) of the entity are identified and external factors (56, 60, 62, 64) that reflect changes in such dependencies are determined. Indicators (58, 68, 70, 72) that affect the external factors are also established and condition levels (59, 69, 71 and 73) are assigned to the external factors based on rules to which such indicators are applied. The performance risk of the entity is evaluated from the condition levels of the external factors.

### CLAIM OF PRIORITY

This application claims priority to U.S. Provisional Application No. 60/874,154 filed Dec. 11, 2006.

### BACKGROUND OF THE INVENTION

1. Field of the Invention

The presently disclosed invention relates to methods and systems for assessing risk and, more particularly, assessing and managing the risk that an entity cannot operate within its normal parameters.

2. Discussion of Prior Art

Methods and systems for evaluating prospective performance among contracting parties, such as suppliers to manufacturing companies, are known. Many prior risk management systems are specifically directed to evaluating and managing vendors of manufacturing companies. One example is seen in U.S. Pat. No. 7,047,208 (“the '208 patent”).

The '208 patent describes a system for monitoring a set of factors that are assumed to be indicative of the vendor's reliability for delivering goods and services. Factors considered in the '208 patent include profit data, financial data, quality data, cost data, delivery data, development data, management data and design data. For example, a manufacturer can secure accounts receivable and payment history data from a vendor's suppliers. Vendor production can be timed according to the manufacturer's production. Data could include the rate of product defects or the timeliness of product deliveries based on the manufacturer's own experience with the supplier. Other data may comprise metrics for the supplier's business operations such as total employment, absenteeism, training data, regulatory violations, and the like. Still other data may include commercially available information about the supplier that can be purchased from commercial data bases such as Dunn & Bradstreet or from public databases such as SEC, court filings, UCC filings, bankruptcy proceedings and other public sources. The vendors are assigned a stability level based on the analysis of the data factors. The data is used to compute short term and long-term warning indicators and the warning indicators are used to evaluate supplier stability.

PCT Application WO 98/29822 describes a system for synchronizing manufacturing schedules among multiple companies and to facilitate the communication of product information from the manufacturer through the distribution chain to the end user.

Lending institutions have used information management software in making new loans and anticipating non-performing loans. The automated systems qualitatively and quantitatively assess credit risks. Functions include examination of profitability, ability to service debt, liquidity, stability of income over time, and capital structure. See “The Loan Rangers: Systems that Fight Bad Risk”, The Automated Banker, January 1991 (pp. 19-23).

In some industries, there has been a growing trend toward closer customer/supplier relationship. In these businesses, the supplier has provided the manufacturer with ever increasing quantities of information. “Supplier Relations in Japan and the United States: Are The Converging?” Sloan Management Review, Helper & Sako, Massachusetts Institute of Technology, Spring 1995, Vo. 36, Number 3, pp. 77-84.

Such prior systems and methods for evaluating and managing risks are generally based on past performance. Such retrospective systems had various difficulties and shortcomings. In some cases, such evaluations simply were based on stale information. More fundamentally, it was found that many times past performance did not account for the interim variation of dynamic risk factors, the appearance of additional new risk factors, or the obsolescence of prior risk factors. Thus, past performance proved to be an unreliable predictor of prospective performance.

More recent risk management systems have improved the accuracy of forecasts of future performance of various entities. However, in many cases, the time horizon for the forecast was too short to enable an affected party to take timely action that would effectively avoid or mitigate the forecasted events. The affected party was appraised that the other party's performance would be impaired or even fails, but the assessment came at a time when it was too late to take action that could mitigate or avoid the consequences of non-performance.

Accordingly, there was a need in the prior art for a method and system that could more reliably assess non-performance risks and that could produce a longer time horizon for assessing non-performance risks. Such a system could evaluate risks in advance of the time when such non-performance becomes manifest or when the consequences of such future non-performance cannot be mitigated or avoided. Therefore, this method and system could afford the affected entity time to take action that could minimize or avoid the adverse consequences of a negative projected outcome or circumstance.

### SUMMARY OF THE INVENTION

In accordance with the disclosed invention, a method and computer program assess the performance risk of an entity based on independent, indirect variables that anticipate and/or more finely resolve an assessment of the risk that an entity will not meet performance expectations. The method and system support assessment of performance risk of an entity that is capable of higher accuracy and earlier recognition in comparison to prior art systems.

The method and computer system identify dependencies that are associated with the entity or entities being assessed. The method and program determine external factors that reflect the state of such dependencies and establish indicators that affect said external factors. Condition levels are assigned to the external factors where the condition levels anticipate a risk condition for the external factors that is based on the indicators that were established. The condition levels that are assigned to the external factors are evaluated to assess the performance risk of the entity.

The method and system determine risk condition levels from indicators that are based on structured data. Preferably, the method and system further determine condition levels based on qualitative data that is secured as responses to specific questions. The specific questions can be posed and the responses can be acquired as part of the disclosed method and system. Incorporation of such qualitative data in combination with the structured data supports an assessment of performance risk that more fully integrates the total business environment of the entity. The qualitative data is scored and related to risk condition levels according to rules and the condition levels based on the qualitative data are combined with the condition levels based on the structure data to provide condition levels for risk categories.

Preferably, the method and computer program assess the performance risk of two or more entities that, in some cases, can be related in a hierarchical pattern. The system can assess the performance risk of each entity in the hierarchy as well as risk relationships between such entities.

In some cases, the entities are related by one of more common dependencies. In those circumstances, the method and system can compare the performance risk of the entities irrespective whether they share common features other than the dependency. This enables the method and system to assess and compare performance risk of entities, whether or not those entities produce similar goods or provide competing services.

Also preferably, the risk condition levels of the external factors are weighted in proportion to the accuracy of the external factors to reliably predict performance risk of the entity. This allows the method and system to emphasize those factors that demonstrate the highest correlation between performance risk predictions and empirical risk results. Also, the risk condition levels can be recorded over time and organized to display changes and trends in the risk condition levels. The data trends provide context for interpreting the results of the performance risk assessment.

In some cases, the external factors are grouped together in categories and the risk condition levels of the external factors are combined to determine a risk condition level for the category.

Also preferably, the method and system make a quantitative assessment of the structured data and qualitative data on which the condition levels are based relative to the entire body of structured data and qualitative data that is potentially available. Advantageously, this provides a basis for assessing the reliability of the risk condition levels that are determined.

The method and system assess environmental influences on the performance risk assessment to provide further context for interpreting of the performance risk assessment and supporting actions taken in response to such assessment. The method and system assess environmental influences by relating goods and services of the entity to environmental risk properties through a classification system for the entity's goods and services. Variations in the risk properties are monitored and the level of risk associated with the risk properties is adjusted to reflect changed conditions that influence the level of risk. Changes in the risk property can be assessed in connection with the interpretation of the performance risk assessment and actions that are taken in response thereto.

Other features, advantages and objects of the presently disclosed invention will become apparent to those skilled in the art as a description of a presently preferred embodiment thereof proceeds.

### BRIEF DESCRIPTION OF THE DRAWINGS

Several presently preferred embodiments of the disclosed invention are described in connection with the accompanying drawings in which:

FIG. 1 is a conceptual illustration of the method of risk management herein disclosed.

FIG. 2 is a diagram that illustrates the interactive data flow for the risk management system herein described;

FIG. 3 is a diagram that illustrates the flow of data from a user of the disclosed risk management system;

FIG. 4 is a schematic diagram that illustrates one hardware embodiment for the disclosed risk management system;

FIG. 5 is a logic diagram that illustrates the function of one embodiment of the disclosed risk management system;

FIG. 6 is a logic diagram that details a portion of the diagram of FIG. 5;

FIG. 7 is a logic diagram that further details a portion of the diagram of FIG. 5;

FIG. 8 is a logic diagram that further details a portion of the diagram of FIG. 5;

FIG. 9 is a logic diagram that further details a portion of the diagram of FIG. 5;

FIG. 10 illustrates a specimen of a screen shot for a “Home Page” of the logic diagram that is shown in FIGS. 5-9;

FIG. 11 illustrates a specimen of a screen shot for a “Search” page of the logic diagram that is shown in FIG. 5;

FIG. 12 illustrates a specimen of a screen shot for a “Supplier (Parent) Summary” page of the logic diagram that is shown in FIG. 5;

FIG. 13 illustrates a specimen of a screen shot for a “Supplier (Subsidiary) Summary” page of the logic diagram that is shown in FIG. 5;

FIG. 14 illustrates a specimen of a screen shot for a “Site Summary” page of the logic diagram that is shown in FIG. 5;

FIG. 15 illustrates a specimen of a screen shot that details an “Environmental Risk” Scatter Plot such as shown in FIG. 12;

FIG. 16 illustrates a specimen of a screen shot that details risk category valuations such as shown in FIG. 12;

FIG. 17 illustrates an alternative specimen of a screen shot for a “Home Page” of the logic diagram that is shown in FIG. 5;

FIG. 18 illustrates an alternative specimen of a screen shot showing a risk view of the relative rank of entities in the logic diagram that is shown in FIG. 5;

FIG. 19 illustrates a screen shot showing a trend of the relative rank over time of an entity that is shown in the “Home Page” of the FIG. 17;

FIG. 20 illustrates a screen shot of a summary of a parent entity shown in the “Home Page” of FIG. 17, including an environmental risk profile for said entity;

FIG. 21 illustrates a screen shot of a summary of a site entity such as shown in the parent entity page of FIG. 20, including examples of key performance indicators;

FIG. 22 is a conceptual illustration of the relationship between key performance indicators, bins and performance categories that are also shown in FIG. 21;

FIG. 23 illustrates a screen shot of a signal on the rating level of a parent such as entity shown in the “Home Page” of FIG. 17, including the rating levels of entities related to the parent entity;

FIG. 24 illustrates a screen shot of a specimen “Case File” that is composed based on an entity such as shown on the “Home Page” of FIG. 17;

FIG. 25 illustrates a screen shot of the task list portion of the Case File” that is shown in FIG. 24;

FIG. 26 illustrates a screen shot of the risk level of a parent entity such as shown in FIG. 20, including navigational details of the screen;

FIG. 27 illustrates and describes detailed structure of the disclosed process for assessing performance risk; and

FIG. 28 shows a logic diagram in accordance with the disclosed method and system.

### DESCRIPTION OF PRESENTLY PREFERRED EMBODIMENTS

The presently disclosed invention concerns methods and systems for anticipating performance risk and changes to performance risk of an entity. As used herein, “entity” is used in a broad sense and means a unit to which a set of performances or operational data points can be reasonably related. Such entities may have relationships, including hierarchical relationships, with other entities. An example of such entities could be a parent corporation, its divisions and subsidiaries. Also as used herein, “performance risk” means the capability of an entity to meet functional requirements that define the purpose or normal operating parameters for the entity.

The disclosed invention's time horizon for anticipating performance risk is long relative to prior methods and systems for assessing performance risk. The presently disclosed invention anticipates performance risk by identifying dependencies or operating conditions that are associated with an entity and determining external factors that are likely to reflect the state of those dependencies or operating conditions. As used herein, the term “dependency” means goods and services that are supplied to or consumed by an entity as part of its routine or normal operations and includes operating conditions for the entity. “Operating conditions” means the normal operating cycle or stable operating pattern for the entity, including planned variations thereof. The external factors are assigned risk condition levels that identify future expected risk conditions for the external factors. The risk condition levels for the external factors are determined by monitoring various indicators where anticipated or actual changes in the indicators will affect the external factors. By monitoring, evaluating and scoring indicators that are relevant to a particular external factor, the disclosed method closely monitors or even anticipates the risk conditions for the external factors that reflect dependencies or operating conditions of an entity. Thus, the method monitors, evaluates and scores relevant indicators to anticipate the entity's performance risk.

In the disclosed method, changes to the indicators affect the external factors. Changes to the external factors reflect changes to the dependencies or operating conditions of the entity. Thus, rather than monitoring the dependencies or operating conditions of an entity directly, the disclosed method monitors indicators that affect external factors. In turn, the external factors reflect a change in state of the entity's dependencies and operating conditions. In this way, the disclosed method assesses an entity's performance risk earlier than risk assessment methods that monitor such dependencies or operating conditions directly.

In some cases, the risk conditions of the external factors are assigned a relative weight. The assigned weight is intended to be in proportion to the degree to which the risk condition is a reliable precursor of the performance risk for the entity. Risk conditions for external factors that more strongly reflect performance risk can be assigned greater weight and risk conditions for external factors that have less potential to reflect performance risk are assigned a lower weight.

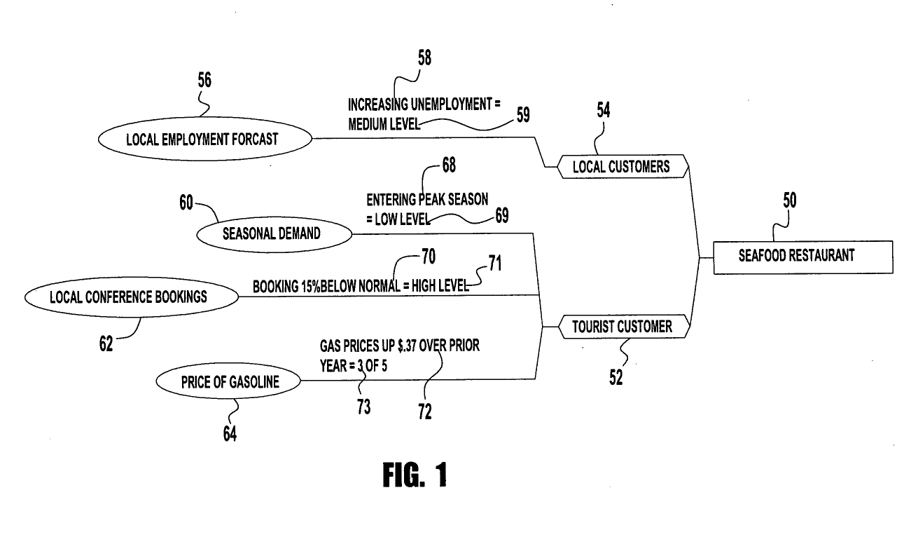

Methods and systems for risk management in accordance with the disclosed invention are conceptually illustrated in FIG. 1. FIG. 1 depicts an example of the method and system as particularly applied to a restaurant entity. However, that example is only for purposes of illustration and does not limit the scope of the invention which is applicable to any operating unit with which performance data or operational data are associated. As discussed more specifically hereinafter, entities that are assessed for performance risk can be independent or can be related in a hierarchical relationship.

In FIG. 1, the entity is a seafood restaurant 50. The capability of entity 50 to meet its operating goals is shown to have two dependencies—tourist customers 52 and local customers 54. It is determined that unemployment is related to an increased risk in loss of local customers so that an external factor 56, local employment forecasts, can reflect the state of dependency 54, local customers. In the example of FIG. 1, external factor 56, local employment forecasts, has an indicator 58, unemployment data. The indicator, unemployment data 58, will affect a change in external factor 56, employment forecasts. The available unemployment data for indicator 58 shows that unemployment is increasing. The method apples a rule to the indicator data 58 to assign a risk condition 59 to external factor 56. In the example of FIG. 1, the rule is that a medium risk condition level 59 is assigned to the external factor, local employment forecast 56, when unemployment is increasing. Based on indicator 58, unemployment data, the external factor 56, employment forecast, is assigned a medium risk condition level 59.

In a similar manner, seafood restaurant 50 is also dependent on tourist customers 52. In the example, three external factors, seasonal demand 60, local conference bookings 62 and the price of gasoline 64 reflect a change in dependency 52, tourist customers. External factor 60, seasonal demand, has an indicator 68, a season of the year, that affects seasonal demand 60. A risk condition 69 is assigned seasonal demand 60 based on a rule that risk is low when indicator 68 is entering peak season. A risk condition level 69 of low is assigned to the external factor season demand 60. External factor 62, local conference bookings, has an indicator 70, booking levels. A risk condition 71 is assigned local conference bookings 62 based on a rule that risk is related to current conference bookings relative to normal (i.e. historical) levels. The risk condition 71 for local conference bookings 62 is high because indicator 70 shows that bookings are 15% below normal. External factor 64, price of gasoline, has an indicator 72, average gas price relative to one year earlier. The risk condition 73 assigned to external factor 64, price of gasoline, is “3 of 5” because indicator 72 shows that gas prices are up 37 cents over the prior year and the rule for assigning risk condition 73 is that high risk is assigned for higher prices according to a preset scale.

To assess performance risk for restaurant 50, the four external factors 56, 60, 62 and 64 are evaluated taking into account their risk conditions 59, 69, 71 and 73. In the case of dependency 54, local customers, the risk is the same as for risk condition 59 of external factor 56 because that is the only external factor related to dependency 54. In the case of dependency 52 (tourist customer) the risk condition is determined by evaluating the combined risk conditions 69, 71 and 73 for external factors 60, 62 and 64. This evaluation can be determined, for example, by comparison of the respective risk conditions of external factors 60, 62 and 64 over time to historical performance of the entity. The risk conditions 69, 71 and 73 of external factors 60, 62 and 64 can also be weighted to reflect the relative potential of the external factors 60, 62 and 64 to reflect performance risk for the entity 50.

Another way of evaluating the risk condition levels of the external factors to assess the risk condition for restaurant 50 is to make the conservative assumption that the risk condition for the entity 50 will be the same as the highest risk condition 59, 69, 71 or 73 of any related external factor 56, 60, 62 or 64. Using this rule, the performance risk for entity 50 is high because the risk condition 71 for external factor 62, local conference bookings, is high.

The presently disclosed invention is not limited to the specific examples for evaluating risk conditions to assess performance risk as herein disclosed. Many other examples of evaluation the risk condition of entities will be apparent to those skilled in the relevant art as the description of presently preferred embodiments of the invention proceeds.

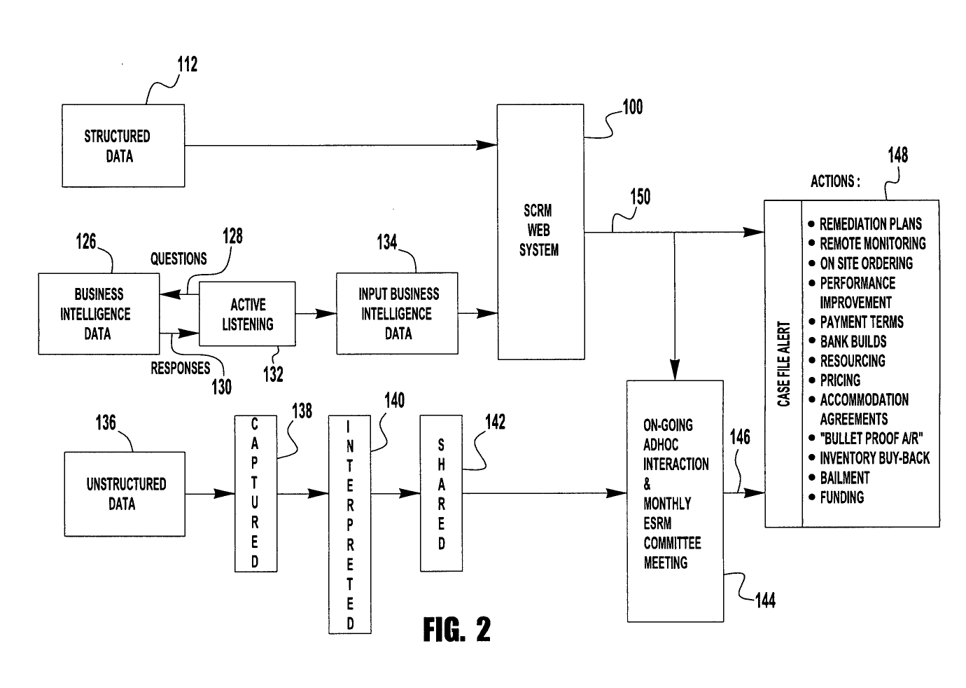

FIGS. 2-4 illustrate a presently disclosed embodiment of a risk management system for implementing the risk management method that is illustrated in FIG. 1. In the example of FIGS. 2-4, the disclosed system is specifically directed to managing the risk to one or more clients 102 such as one or more manufacturing entities. The performance risk that is assessed is the risk presented by one or more supplier entities that provide goods or services to the client 102. However, the scope of the presently enclosed invention is not specifically limited thereto and those skilled in the art will understand that the invention can be otherwise applied to other risk analysis as, for example, in areas of retail sales, retail restaurants (see FIG. 1), military preparedness, airport security, employee reliability and many other applications.

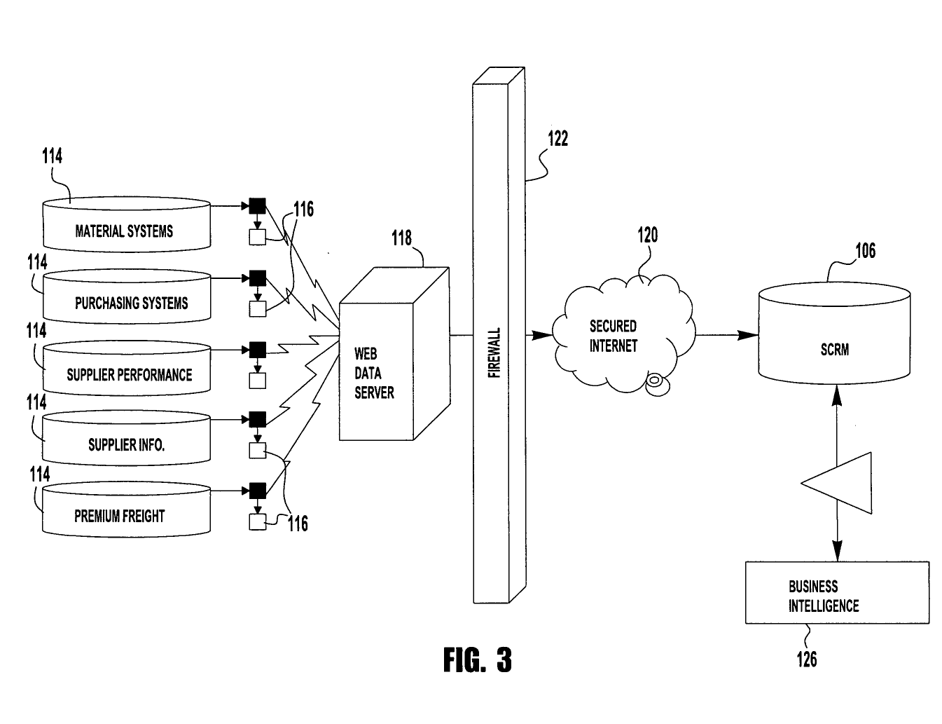

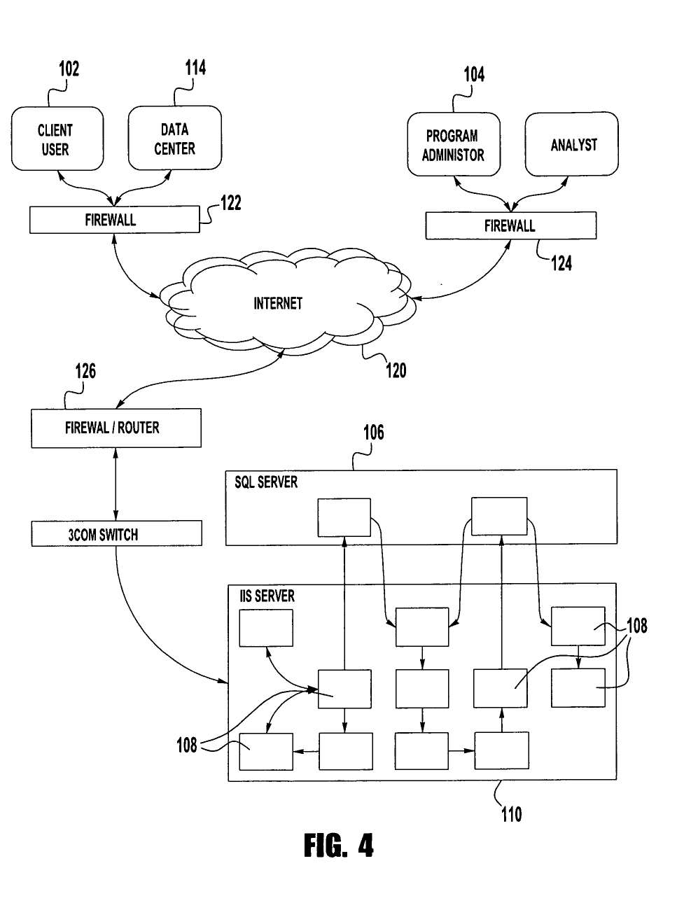

FIGS. 2 and 3 illustrate the data flow in the risk management system. FIG. 4 is a schematic diagram that illustrates a general hardware configuration 100 for the disclosed risk management system. As shown in FIGS. 2-4, the clients 102 are manufacturing entities that cooperate with one or more program administrator(s) 104 to provide data to a machine-readable storage having a computer program stored thereon.

In the example of the preferred embodiments, the machine-readable storage 106 can be a relational database management system in combination with an internet information services server that provides Web application infrastructure. For example, the relational database management system can be a SQL server which is commercially available from Microsoft Corporation and the internet information services server can be a Microsoft IIS which is also commercially available from Microsoft Corporation.

The computer program stored on servers 106 has a plurality of code sections that are executable by servers 106 to cause the servers to perform the step of populating a plurality of data fields 108 in a memory 110 with structured data 112, business intelligence data 126 and other relational data in accordance with the disclosed invention and as will be apparent from the disclosed embodiments. The program is developed as required by the particular circumstances in accordance with commercially available software tools which are known and used by those skilled in the art. For example, such software can be Visual Studio 2005 utilizing a managed code programming model such as .Net 2.0 Framework for building Web applications and database applications. Such software is commercially available from Microsoft Corporation.

In the embodiment of FIGS. 2-4, the structured data 112 that populates the information data fields 108 is obtained from established sources such as client data bases 114 illustrated in FIG. 3. Structured data 112 is data that available to the client and that represents quantifiable information that is relevant to the supplier entity in question. More particularly, the structured data is data that serves as or supports indicators for the risk condition of external factors as hereinafter more fully explained. By way of example, structured data 112 can be selected from data that includes product quality data, product delivery data, and financial data. Examples of such data can be shipping notices, parts quality, parts release data, payment terms, receipts, defect rates, financial rating and many other types of information data. Structured data 112 can be updated to servers 106 on a real-time basis or according to a time schedule. Structured data 112 also can be monitored and recorded over time so that a history of structured data 112 is developed.

In the system of FIGS. 2-4, structured data 112 is encrypted at 116 and sent from a client web server 118 to servers 106 through a secure internet link 120. Similarly, data transferred between servers 106 and the program administrator 104 is encrypted and sent through secure internet link 120. The client 102 and the program administrator 104 can also communicate directly, sending encrypted data through secure internet link 120. Client 102, program administrator 104 and servers 106 are each protected by security firewalls 122, 124 and 126 respectively. The encryption and secure internet transmission by the system servers and internet link 120 employ commercially available hardware according to methods that are known to those skilled in the art.

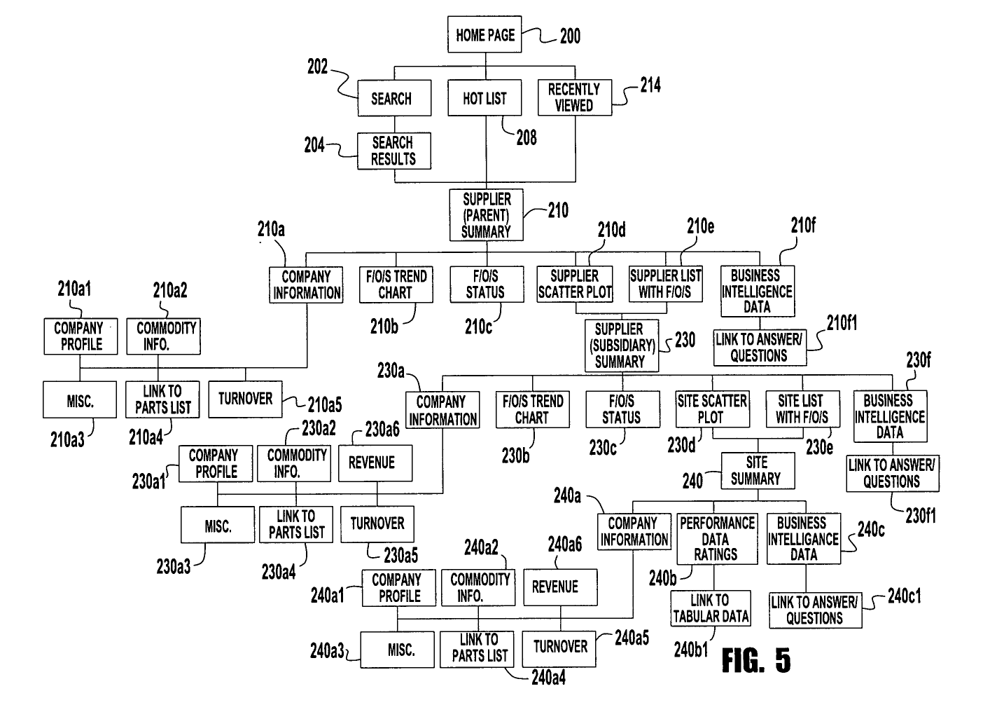

The system assesses the performance risk of supplier entities to clients 102. As hereinafter more fully explained in connection with FIGS. 5-27, the performance risk is assessed by identifying, for each suppler entity, dependencies and operating conditions that are associated with that supplier entity. In addition to identifying the dependencies and operating conditions for an entity, external factors that reflect the dependencies and operating conditions are also determined. As further explained in connection with the embodiments of FIGS. 2-27, external factors are also sometimes referred to as “performance indicators” or “key performance indicators” (herein also “KPIs”). The external factors or KPIs are selected as factors that reflect changes in the state of an entity's dependencies and operating conditions. Thus, by monitoring external factors or “KPIs,” the system indirectly views the entity's performance risk through the prism of dependencies and operating conditions of the entity.

To monitor the external factors or KPIs, the system 100 further establishes indicators. As used herein, the term “indicators” means anticipated or currently known changes that will affect the external factors or KPIs. The system 100 acquires data that is relevant to the established indicator and applies the data according to rules to assign a risk condition level for the external factor or KPI. The performance risk for the entity is then assessed by evaluating the risk conditions that are assigned to the KPIs that are relevant to that entity. Thus, indicator data allows the system 100 to determine a risk level for the KPI that leads the performance risk for the entity.

Various rules can be used for assigning the condition levels. The rules can be manuscripted for the particular indicator data and KPI. In some cases, the rules are manuscripted based on the particular metrics and the relationship of those metrics to the performance risk as empirically determined or as may be estimated. In the example of the preferred embodiment, program administrator 104 can select a rules set from Instance Count, Value Range, and Instance Ranges. The “Instance Count” rules set determines the number of times an event occurs within a given time period. The “Value Range” rules set interpret numerical values within ranges to establish warning levels. The “Instance Ranges” rules set determines the number of times an event occurs within a plurality of given time periods to establish warning levels.

As further explained in connection with FIGS. 5-27, the risk conditions can be evaluated in a number of ways to assess the performance risk for the entity. For example, the risk conditions can be grouped together in related categories and the performance risk can be determined according to a rule that establishes performance risk in accordance with the risk conditions determined for the categories. Alternatively, the performance risk can be equated to the highest risk condition for any single category.

Also, the risk conditions of the KPIs, or groups of KPIs, can be weighted according to the relative importance of the KPIs in assessing or predicting the performance risk for the entity.

The example of FIGS. 2-27 assesses performance risk for a number of entities that are associated in hierarchical relationship. Namely, the entities are the respective parent and subsidiary members of the corporate families of the suppliers. As more specifically discussed in connection with FIGS. 5-27, the system 100 analyzes the performance risk of each member of the corporate family and allows the client 102 to view the results of such analysis separately with respect to each member.

As also further explained, the system 100 is capable comparing together the entities that share common dependencies and operating conditions. The system 100 can associate KPIs together in categories to determine a risk level for the category and monitor risk trends in the category. This allows the system to compare the performance risk of one entity with the performance risk of other entities having comparable KPIs to provide a relative measure of the performance risk.

The system 100 secures two classes of data that are relevant to the risk levels that are established for the KPI categories. As particularly shown in FIG. 2, system 100 is responsive to structured data 112 and also business intelligence data 128. In addition to populating the information data fields 108 with structured data 112 that is obtained from sources such as client data bases 114, the servers 106 can also issue business intelligence questions and record the responses to those business intelligence questions. Such business intelligence questions seek qualitative information that is anticipated to exist and that is relevant to the business risk associated with the supplier. However, business intelligence data is qualitative data that is not directly apparent or available from structured data.

The business intelligence questions are prepared and provided to server 106 by the client 102 or the administrator 104 either separately or in cooperation. Business intelligence questions seek qualitative data regarding risk aspects of the subject entity. Typically, business intelligence questions are manuscripted for a specific entity and are framed to require responses that evaluate factors that bear on the business risk of an entity. Such responses require the exercise of judgment in evaluating the strength or relevance of such factors. These responses are illustrated in FIG. 2 as business intelligence data 126. For example, business intelligence data 126 can be supplier request data, press release data, and market activity data. Business intelligence data 126 can be monitored and recorded over time so that a history of business intelligence data 126 is developed.

As also illustrated in FIGS. 2-4, client 102 or program administrator 104 can acquire business development data 126 as responses to business intelligence questions by questioning information sources directly to secure business development data 126 and then enter that business development data 126 in system 100. Servers 106 can receive business intelligence questions and make them available to client 102 or to other potential sources of business intelligence data.

As shown in FIG. 2, business intelligence data 126 can be acquired through “active listening” of the client 102 and/or administrator 104. In the examples of FIGS. 2-4, business intelligence data 126 can be new or updated qualitative data concerning suppliers that is developed through active listening 132. At active listening 132, client 102 and/or administrator 104 prepare business intelligence questions 128 and enters them in the system 100. Client 102 and/or administrator 104 develop business intelligence data 126 as responses 130 to questions 128 which are posed to various potential information sources.

Client 102 or program administrator 104 can prepare questions that are designed to elicit business intelligence data 126 from various sources. The client 102 and/or program administrator 104 can analyze prior responses to questions to form additional questions or to identify business intelligence data 126. The computer program can cause the servers 106 to provide prompts to both client 102 and to program administrator 104 to assist the client and the program administrator in acquiring the business development data.

The business intelligence questions 128 are designed so that responses 130 to the business intelligence questions 128 can be assigned a predetermined point score, depending upon the substance of the response. The point score of business intelligence data 126 is aggregated as responses 130 are accumulated. As shown in FIG. 2, through active listening 132, the program acquires business intelligence data 126 and at business intelligence data input 134 inputs the acquired business intelligence data 126 to system 100. The system assesses the business intelligence risk based on the point score of the business intelligence data 126.

At business intelligence data input 134, the business intelligence data 126 can be organized in categories such as strategic, operational or financial categories. The business intelligence data 126 can be weighted according to the judgment of client 102 and/or administrator 104 as to its likely significance and its reliability. Risk levels based on the weighted business intelligence data in each category can be developed based on the aggregated point totals for that category. The point totals can be applied to a rule to obtain the risk level for the business intelligence category. The risk levels for business intelligence categories can be tracked and combined with risk levels based on the structured data in the same category to develop a risk level for the entity category. The analysis can include evaluating the quality of the structured data, the business information data, or both the structured data and the business information data. The data can be analyzed to chart one or more trends such as financial trends, operational trends and strategic trends. The category risk level for the entity can then be used to assess the performance risk for the entity.

In some cases, the servers 106 can integrate structured data 112 with business intelligence data 126 that is secured from business information sources. The integrated structured data and the business intelligence data can be used to assign a risk condition for the combined data. Changes in the risk condition of the combined data can be tracked and a history maintained to produce a trend chart for the risk.

The structured data and the business intelligence data can be arranged in sets with each data set corresponding to a respective entity. The different data sets can be collaterally related such as representing two competing suppliers. In that case, the definition for a performance data set includes one or more codes that are classified so that the data sets can also be grouped by class or sub-class according to the codes. In this way, the system can compare entities that share a common dependency by relating the risk levels of KPIs corresponding to those entities.

Also, the different data sets can be hierarchically related such as representing a parent corporation and its subsidiary. In that case, the definition for a performance data set also includes the entity level for each data set as well as the inheritance direction for the data (i.e. up or down). The program administrator 104 can select from a number of rule sets for interpreting and scoring the information. In this way, the system can provide clients with a hierarchical view of supplier data at any level from corporate parent to subsidiary to operating facility.

As illustrated in FIG. 2, the risk assessment based on business intelligence data 126 that is acquired in accordance with the presently disclosed method and system is distinguished from assessments of the type on which prior risk assessment systems and methods have relied. In addition to structured data 112 and business intelligence data 126, FIG. 2 shows a risk management process that incorporates unstructured data 136. As previously explained herein, structured data 112 is data that is related to a KPI indicator. Structured data 112 quantitatively supports the application of a rule to assign a risk condition to the related KPI. Business intelligence data 126 is response data to specific questions that are designed to elucidate qualitative information concerning an entity. Such qualitative information is within the client knowledge base of the client or public and is relevant to the performance risk of an entity, but is not in the form of structured data that can support an indicator for a relevant KPI.

FIG. 2 shows that risk assessment can include unstructured data 136 in addition to structured data 112 and business information data 126. Unstructured data 136 is information that is not business intelligence data 126 that can be scored nor is it structured data 112 that is evaluated under a KPI indicator rule. Unstructured data 136 is merely available general information that a decision-maker may choose to consider in determining what action to take in connection with the performance risk of a particular entity. Unstructured data 136 is captured 138, interpreted 140, and shared 142 in the classical manner. Typically, this information is available at a committee meeting 144 or other decision-making event and may be consulted on an ad hoc basis as at 142. In the example of FIG. 2, the results 146 of committee meeting 144 may be shared with or recommended to an ultimate decision maker 148. The decision maker 148 may consider such results 146 together with the performance risk assessment 150 of the presently disclosed system 100.

As shown in FIG. 2, the computer program can develop recommended management actions in response to the analysis of the performance risk for the entity. The management recommendations can be risk management assessments, risk reduction techniques, or combinations thereof. For example, the program can recommend management actions that include: remote monitoring, on-site ordering, terms of payment, pricing, inventory buy-back, and other actions. Management recommendations can be accessed, reviewed and analyzed by one or more of clients 102 and/or one or more of the program administrators 104 who can decide whether to implement the recommended actions.

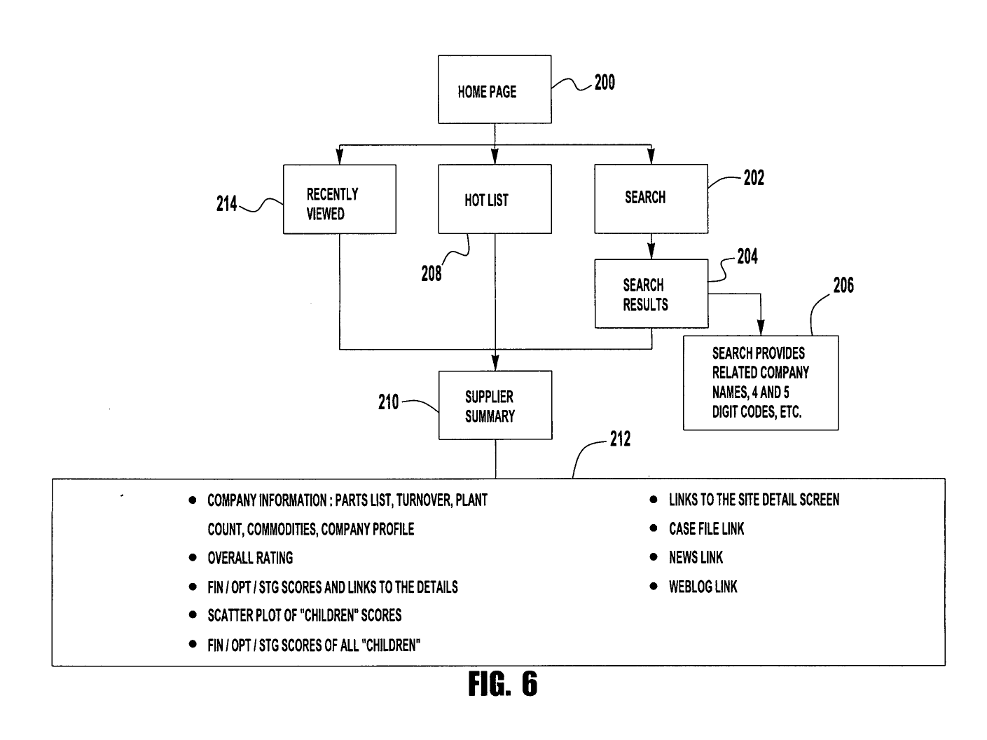

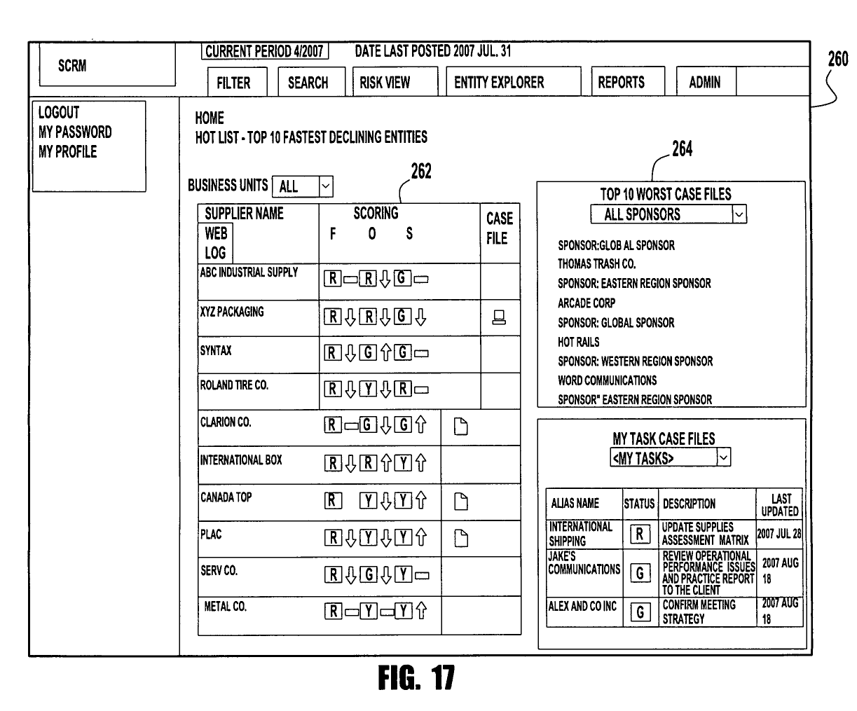

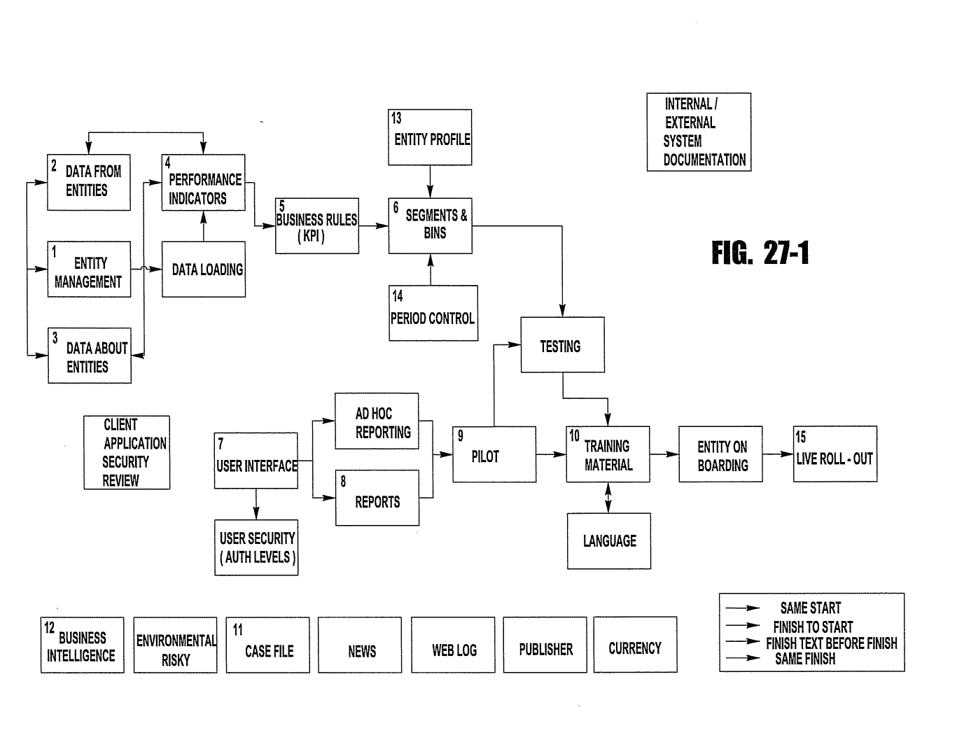

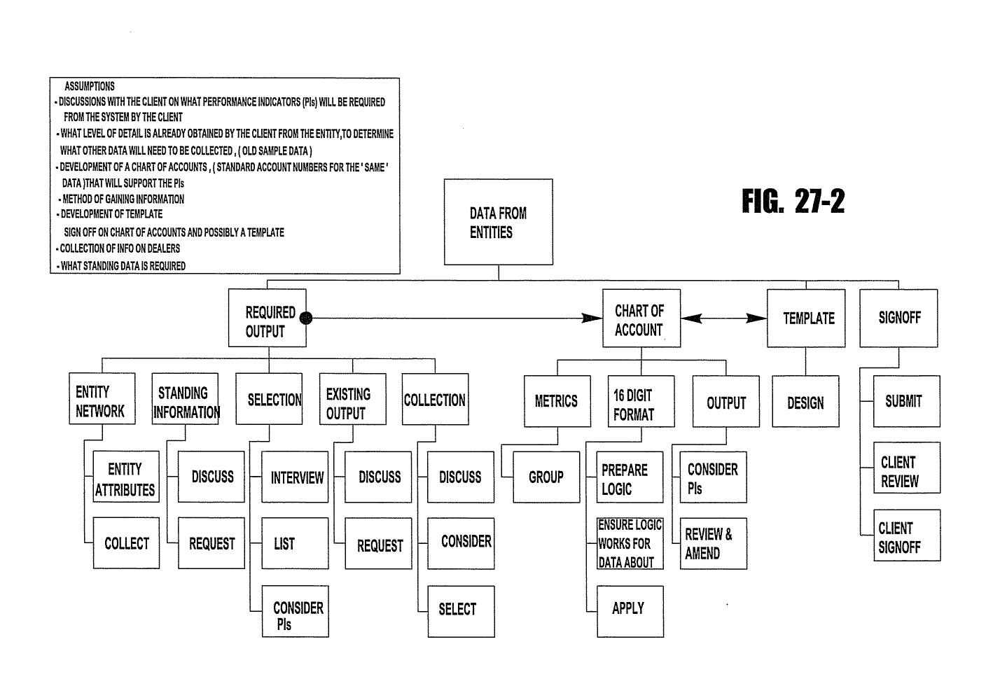

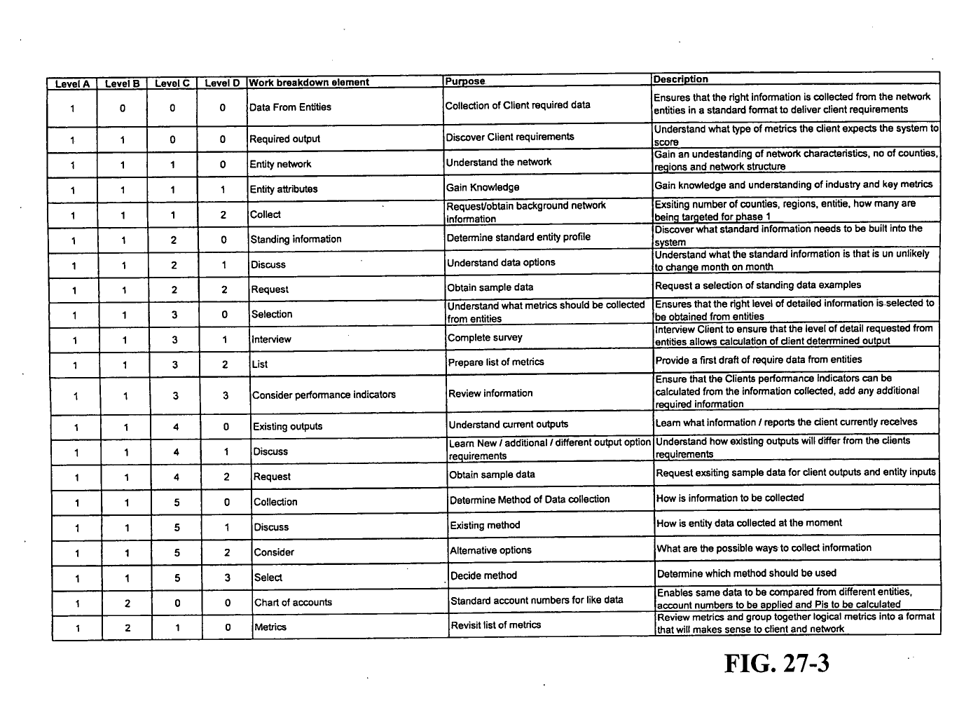

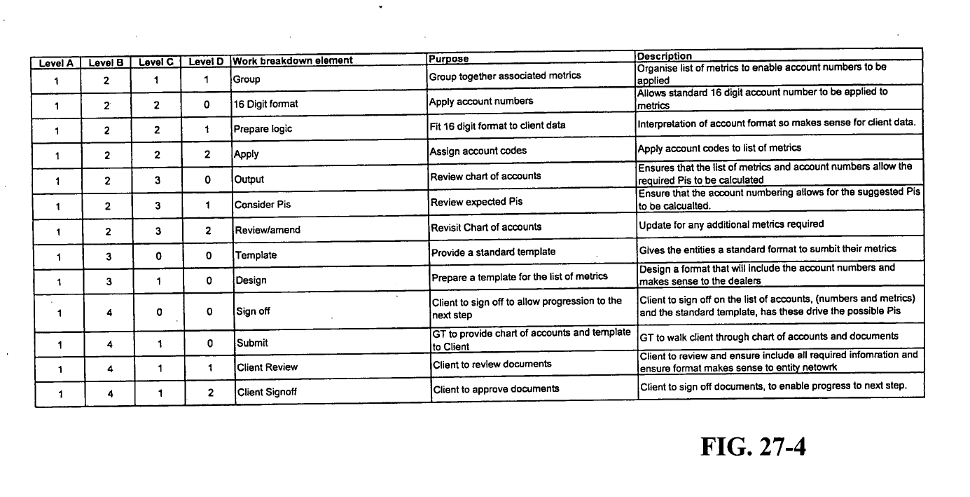

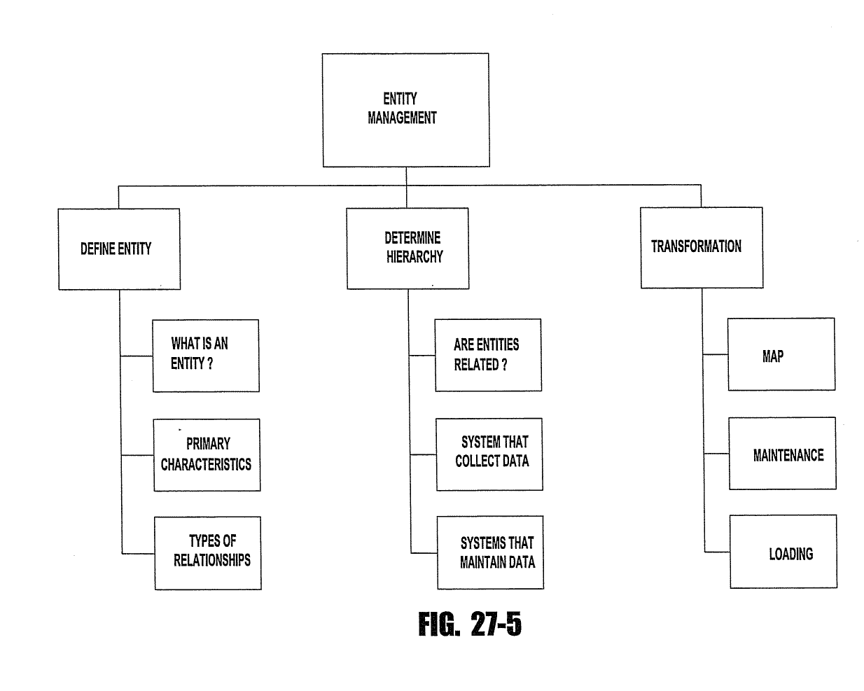

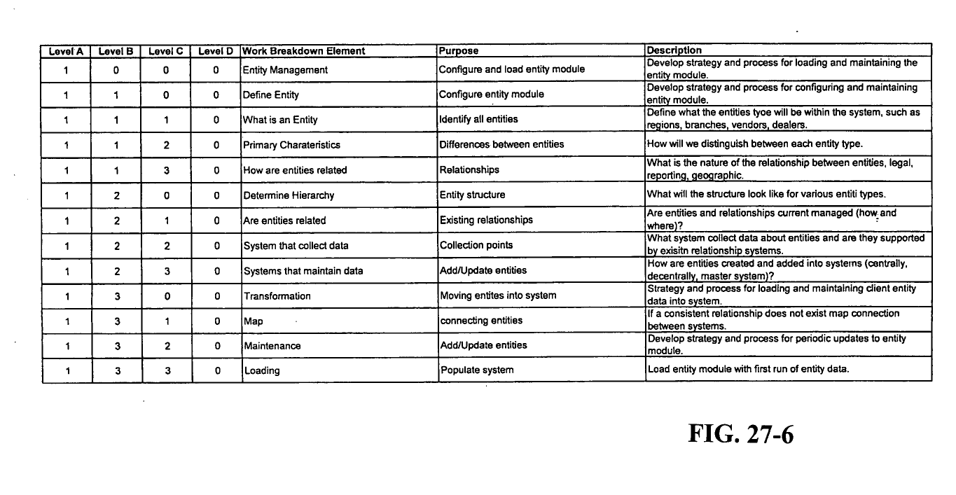

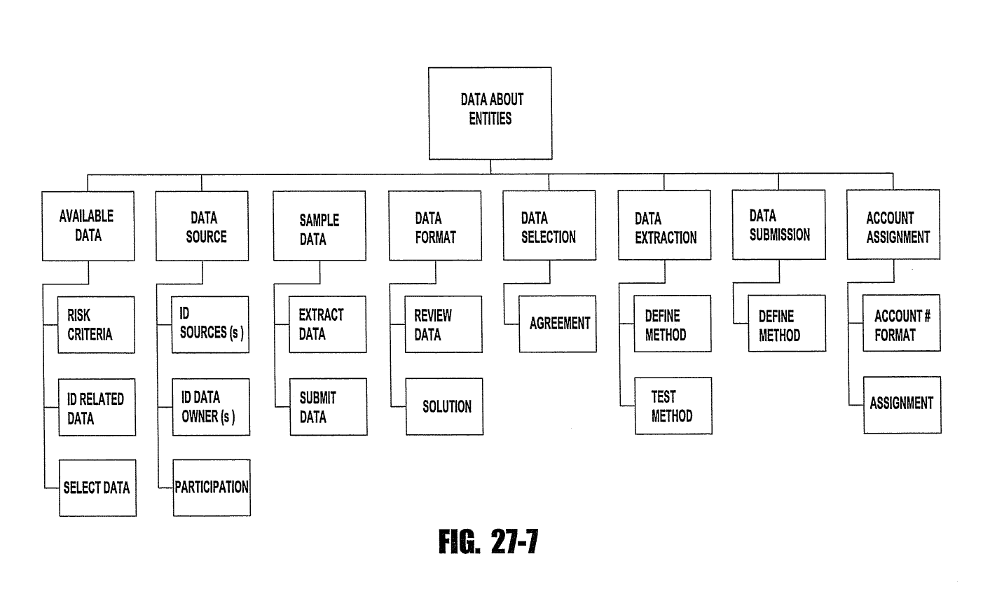

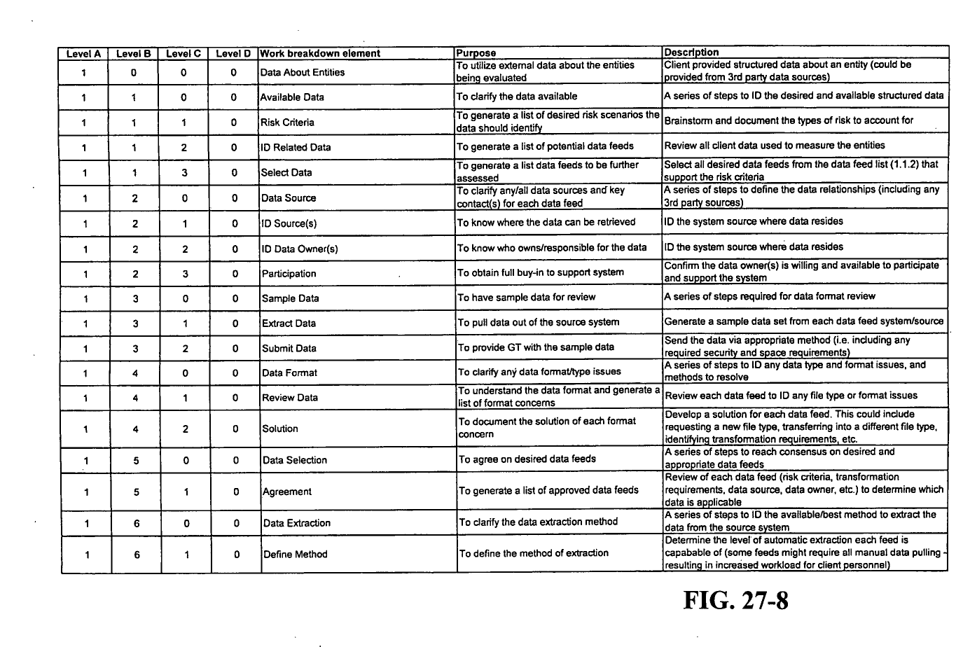

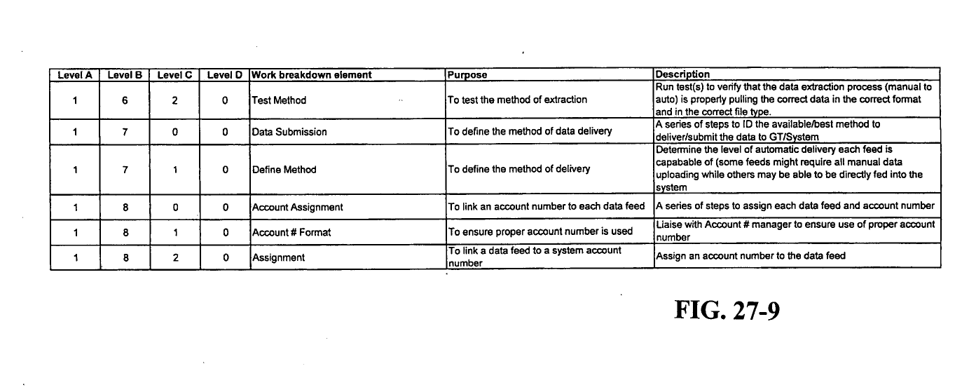

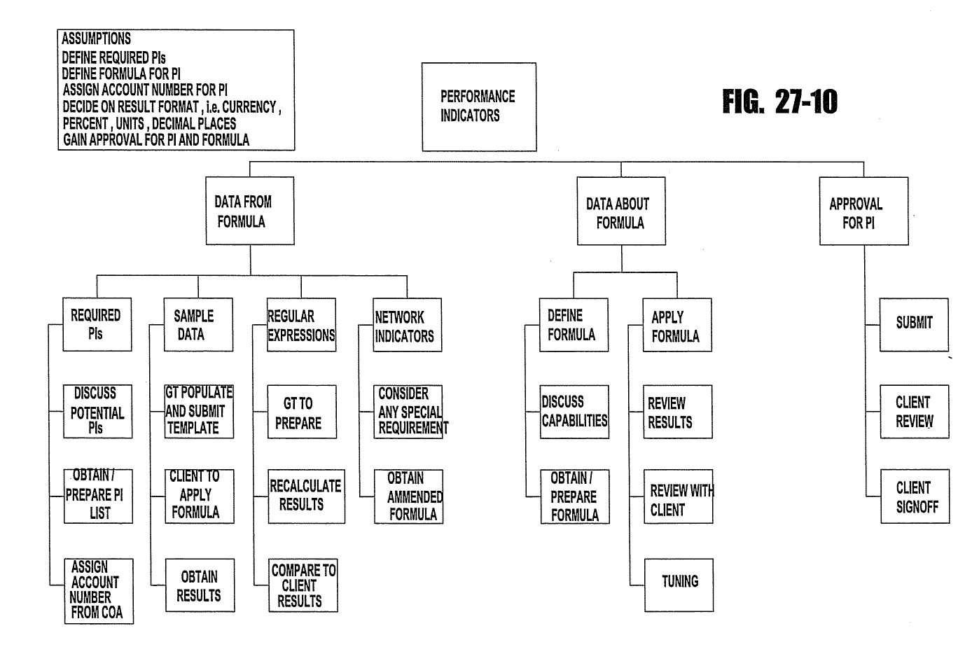

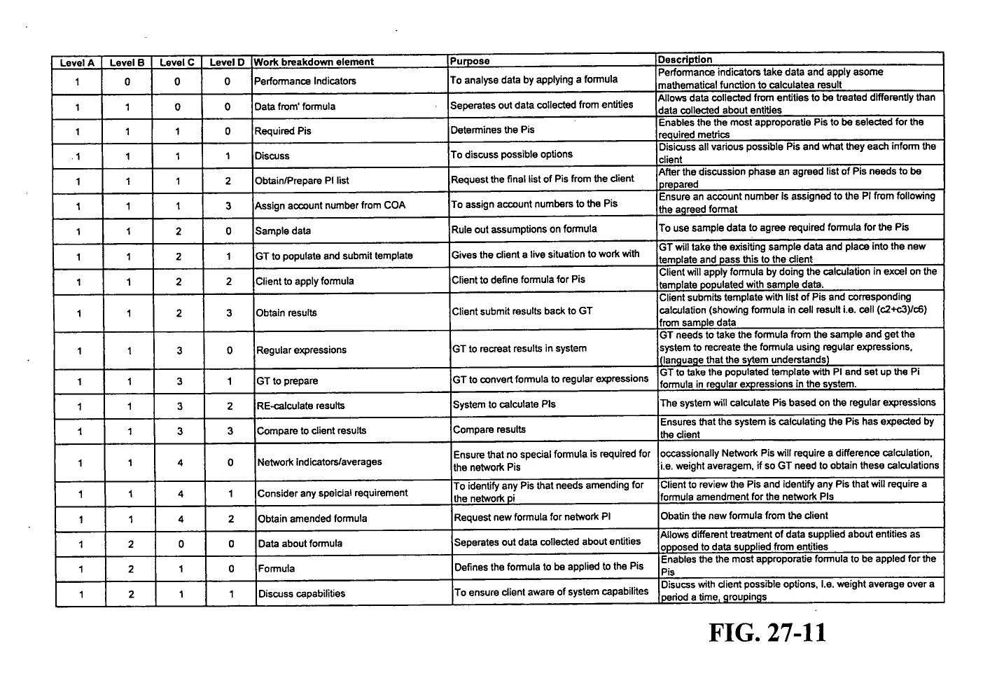

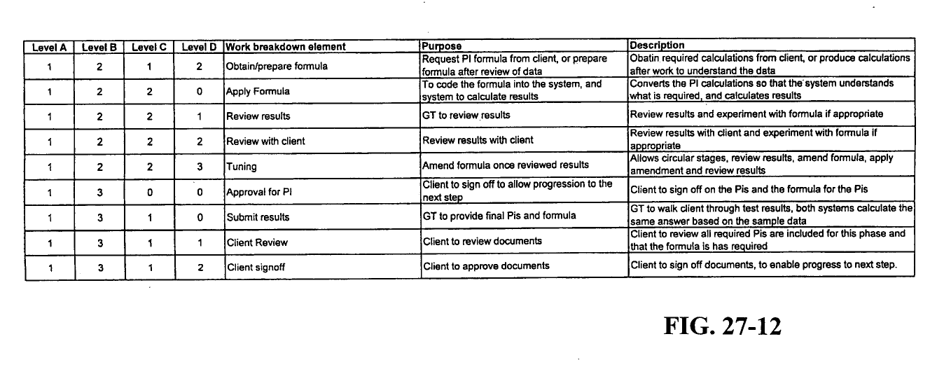

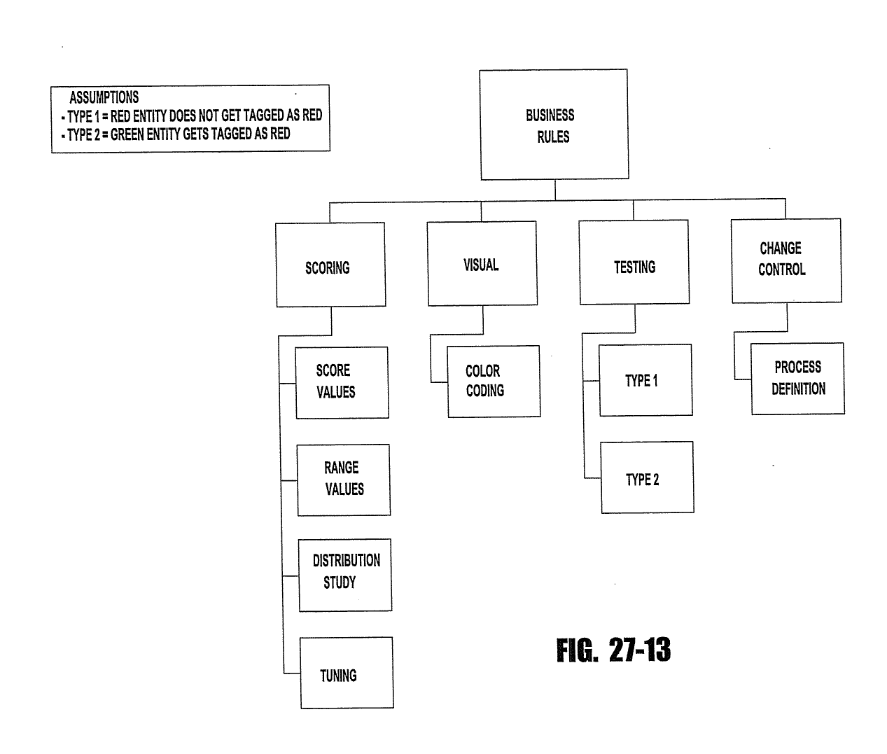

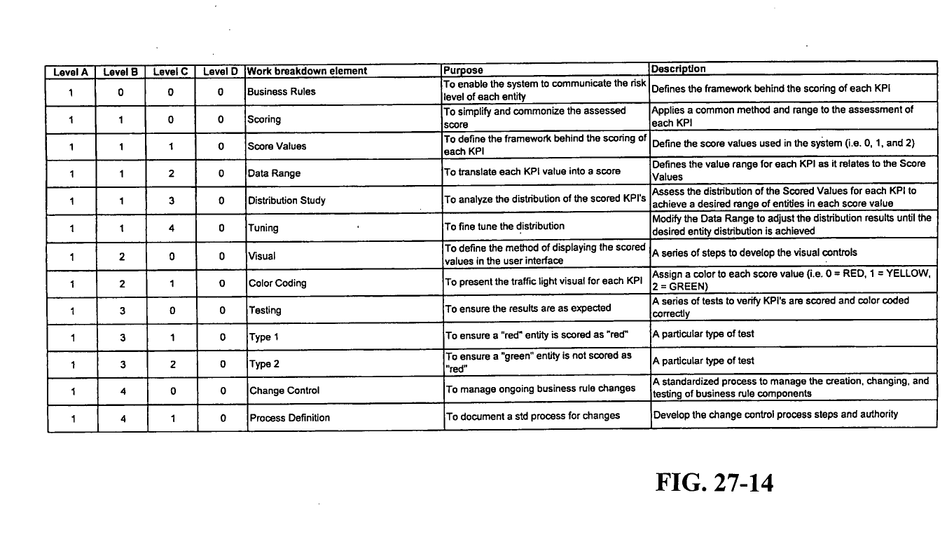

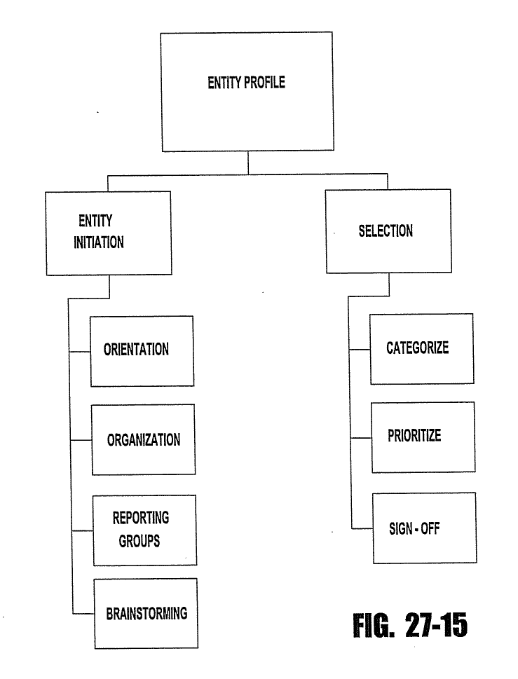

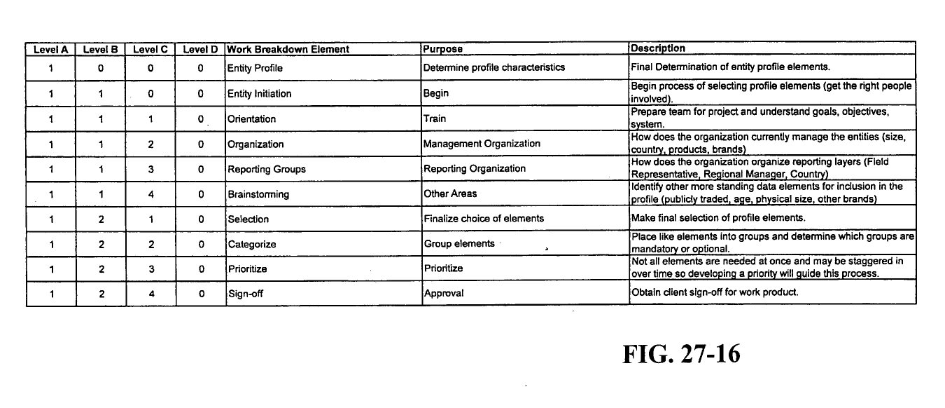

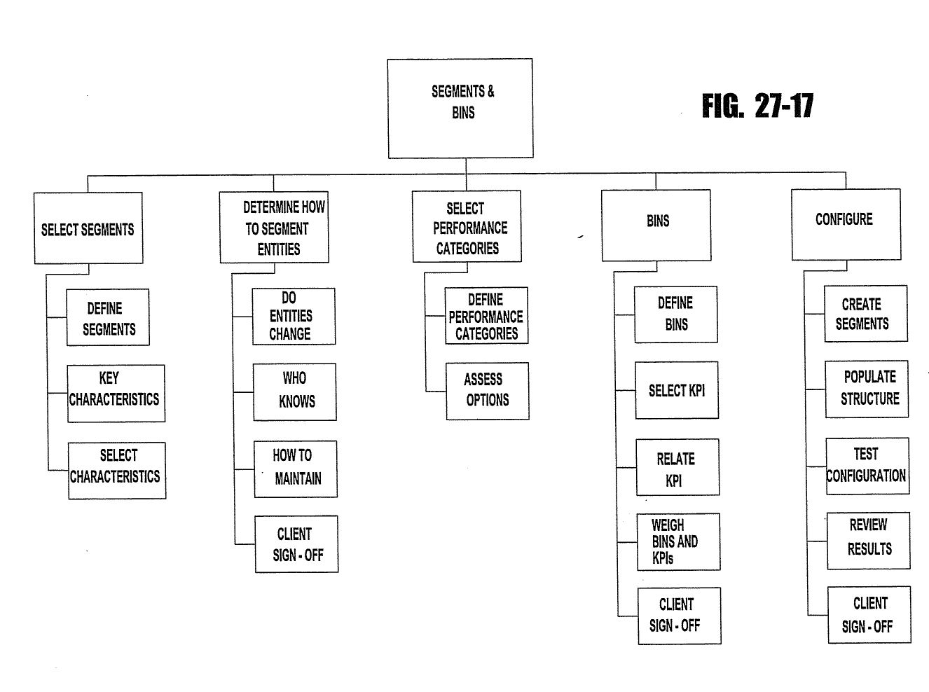

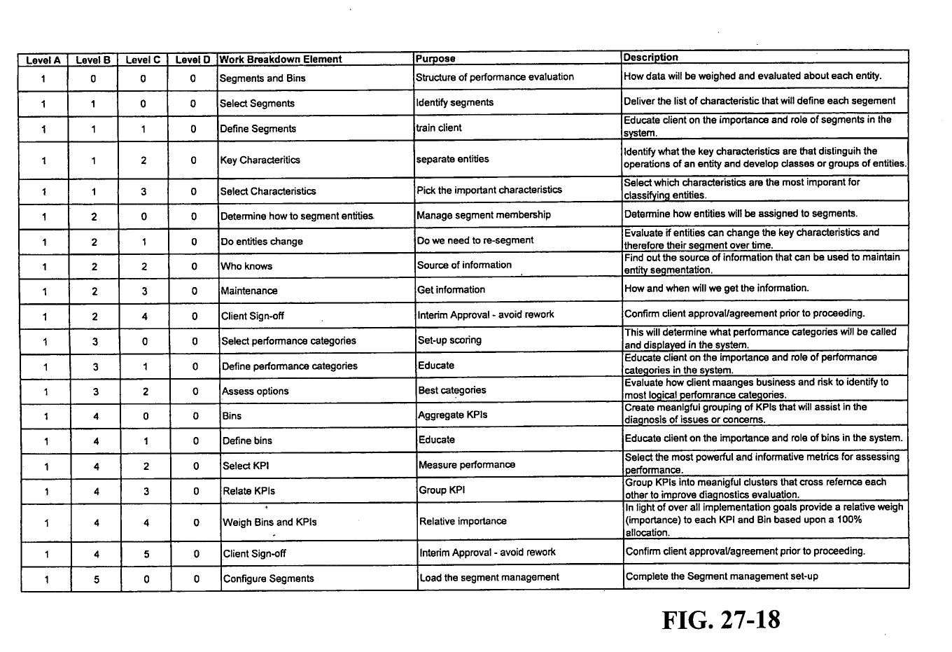

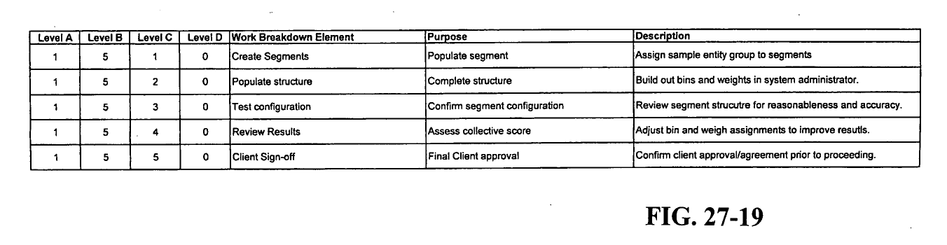

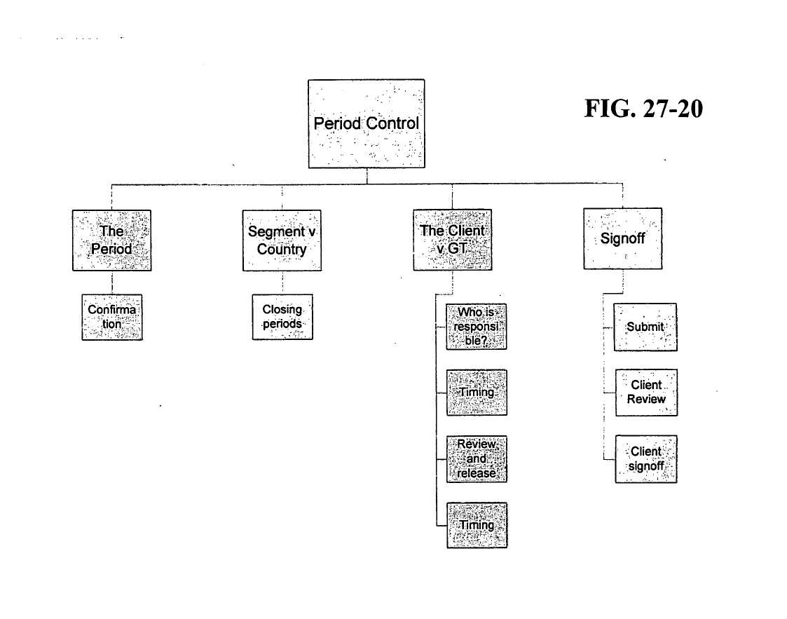

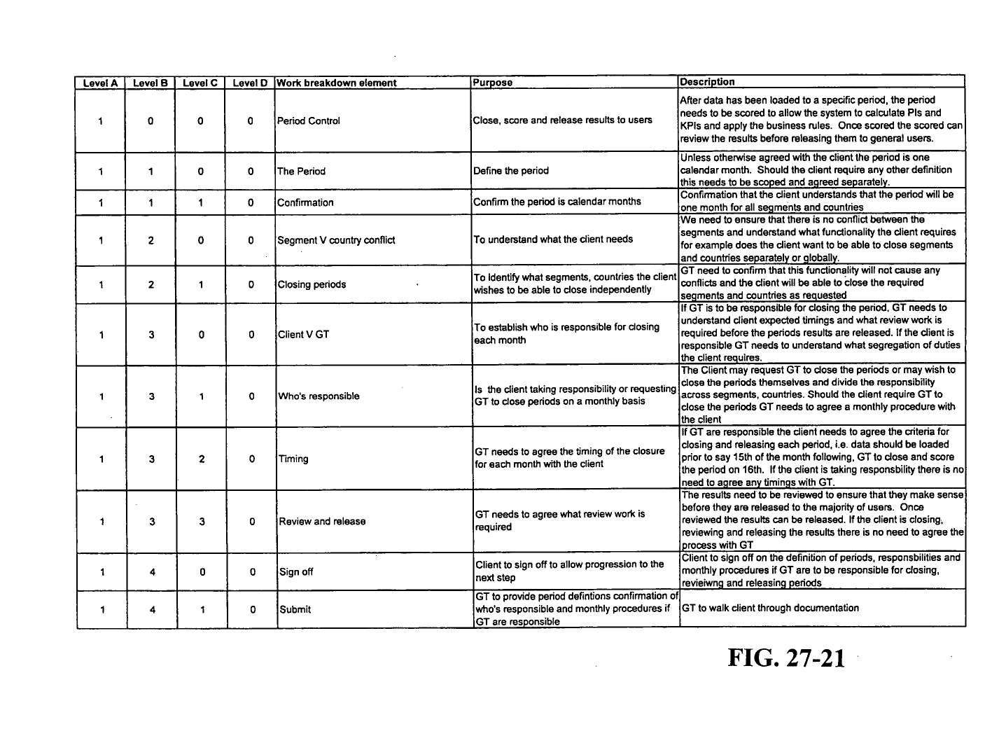

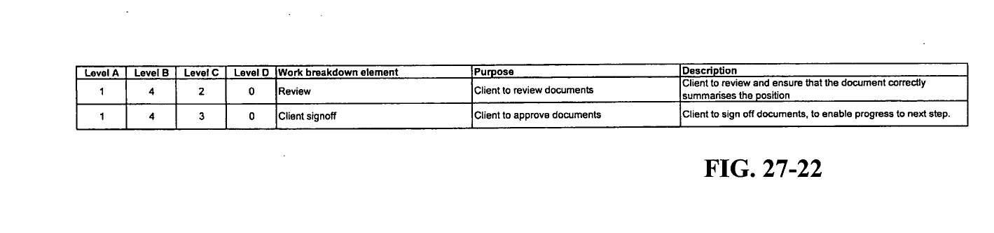

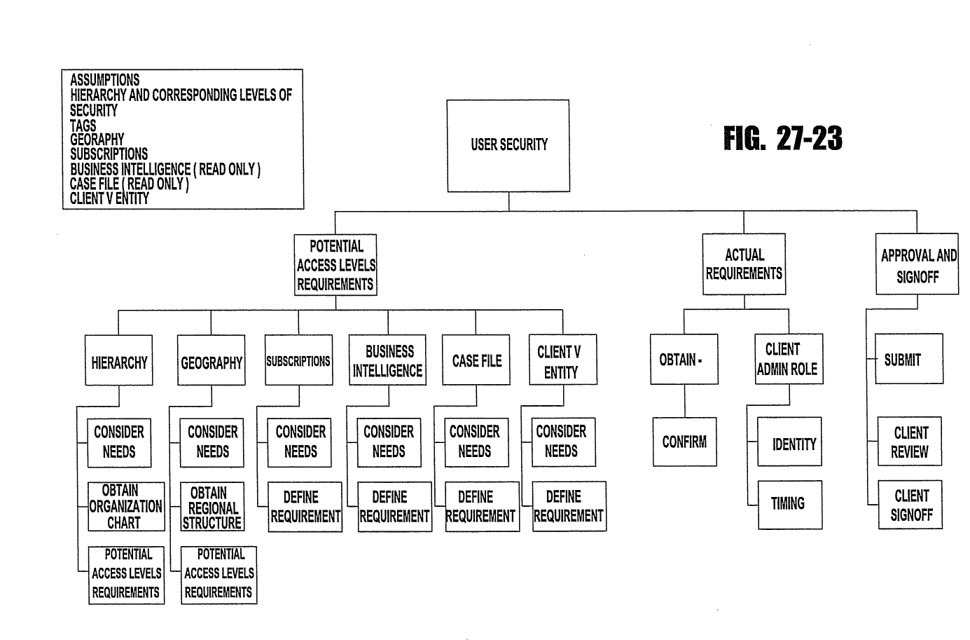

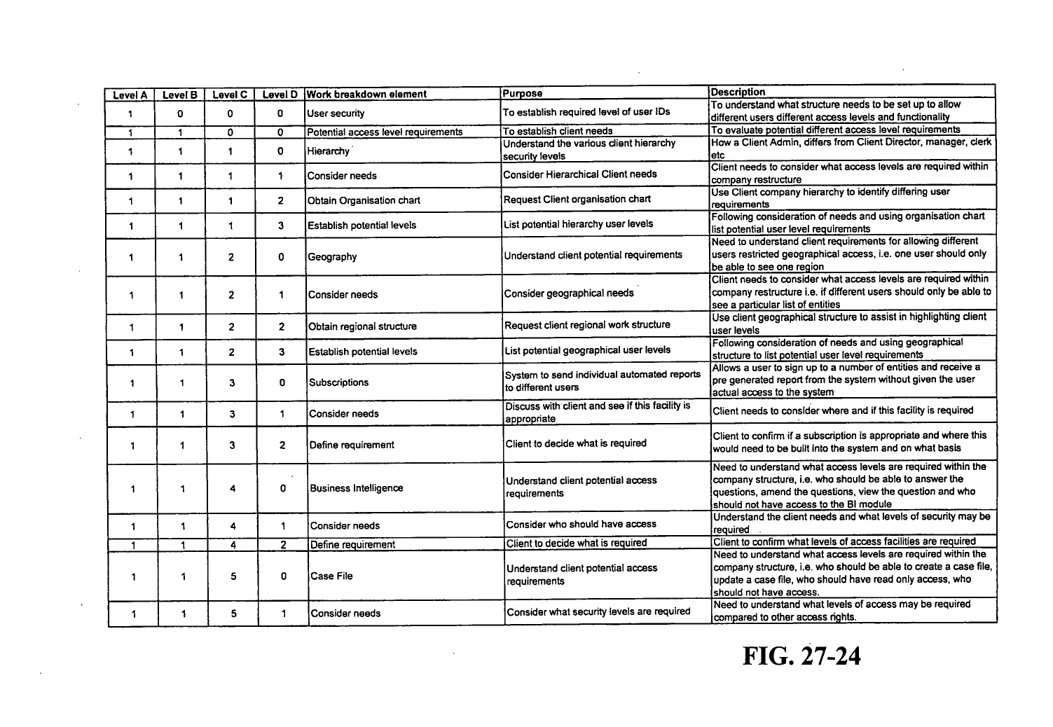

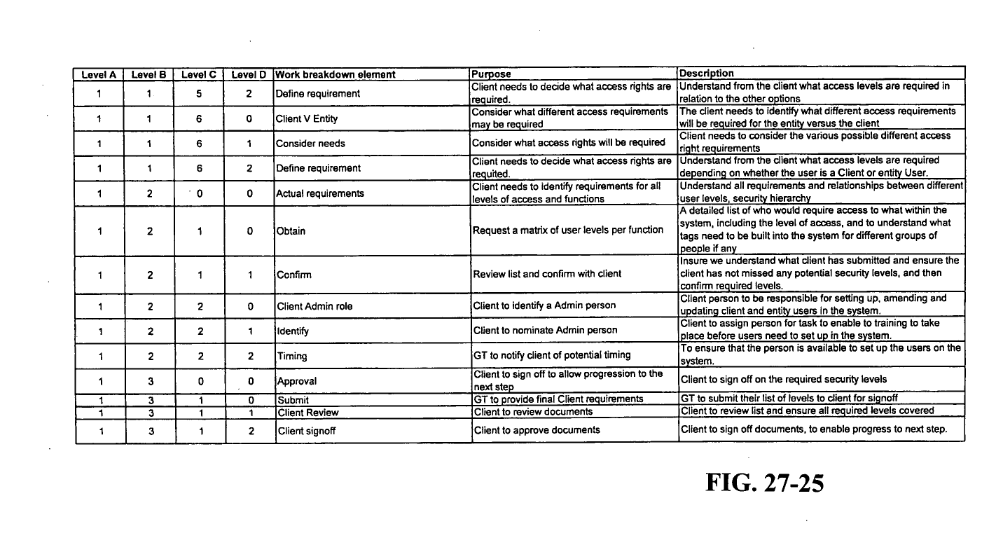

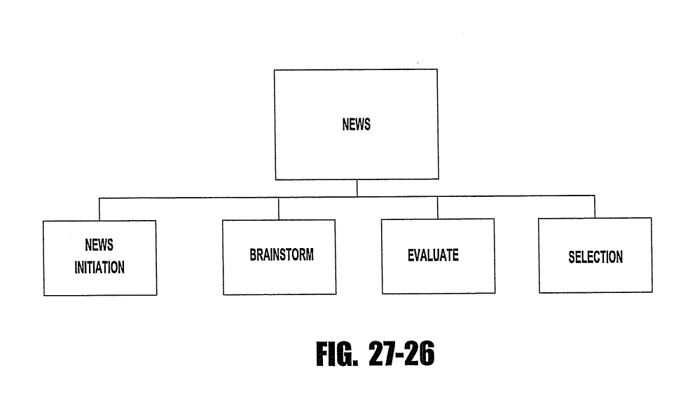

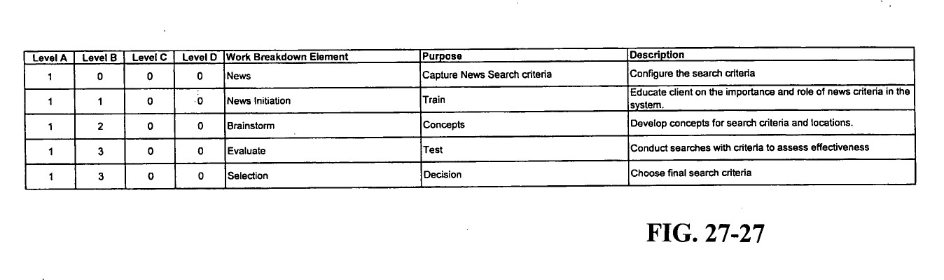

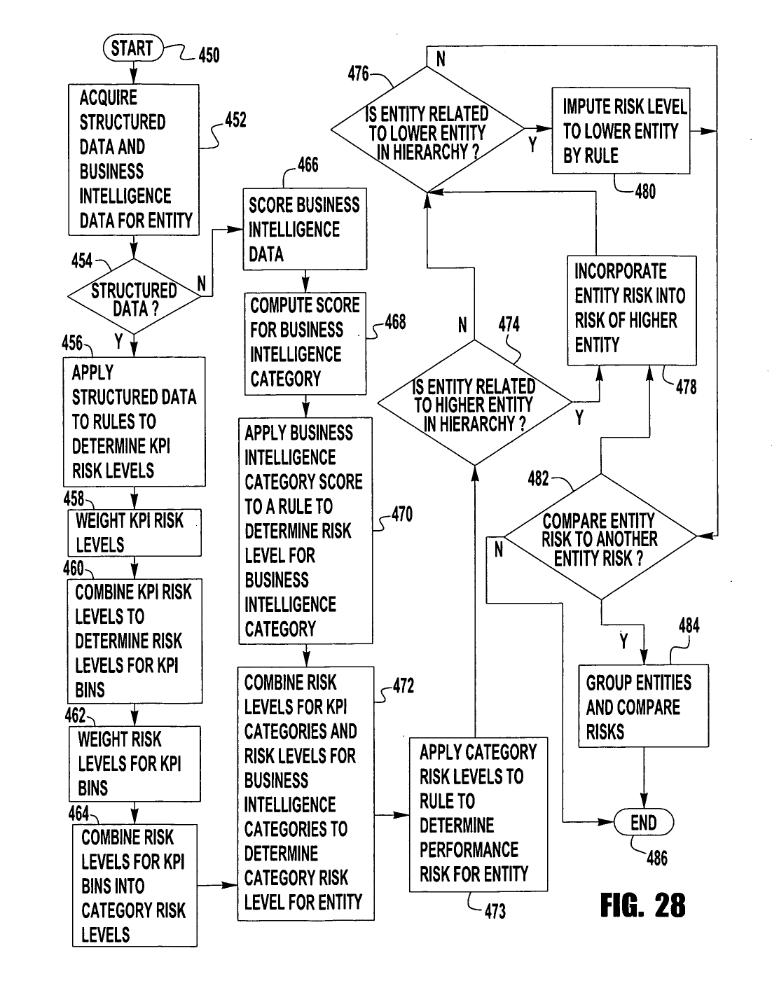

In the example of the preferred embodiment of FIGS. 2-27, the system develops performance risk assessments with respect to a plurality of companies or other entities who are suppliers to a manufacturing company. FIGS. 5-9 and 28 are logic diagrams for the system. The overall logic flow and relationships of the entities is best shown in FIGS. 5 and 28. FIGS. 6-9 further describe access to the performance risk assessments and the supporting data in the context of FIG. 5. FIGS. 10-16 represent an embodiment of screen shots corresponding to portions of FIGS. 5-9. FIGS. 17-26 represent an alternative embodiment of screen shots that also correspond to portions of the logic diagrams of FIGS. 5-9. FIG. 27 is a detailed explanation of an implementation of the disclosed method and system.

FIG. 28 is a logic diagram that illustrates data flow in a performance risk analysis of an entity in accordance with one embodiment of the disclosed system and method. In FIG. 28, it is assumed that the entity is associated with structured data that forms KPI indicator data for the entity as previously explained herein. The entity KPIs are arranged in groups or “bins” and the KPI bins are organized in categories. It is further assumed that the entity is associated with business intelligence data as also previously explained and that the business intelligence data is organized in categories that correspond to the KPI categories.

The KPI structured data and the business intelligence data for the entity are acquired at 452. At 454 the KPI structured data and the business intelligence data are separated for further processing. At 456 the KPI indicator data is applied to a relevant rule to produce a risk level for the KPI. As also previously explained, the rules associate the KPI indicator data with risk levels and are developed through study of empirical data or by other means by which the KPI indicator is rationally related to a risk level for the KPI. The KPI Risk levels are weighted at 458 relative to the magnitude or degree that the risk levels affect the KPIs and/or the KPIs are deemed to accurately reflect performance risk. At 460 the KPI risk levels are combined to determine risk levels for the respective KPI bins and at 462 the KPI bins are weighted according to importance that the bins have in accurately determining performance risk for the entity. At 464 the weighted risk levels for the KPI bins are combined to form risk levels for the respective KPI category.

Returning to the processing of the business intelligence data, the business intelligence data is scored at 466 and the numerical scores for each category are computed at 468. At 470 the computed category scores for the business intelligence are applied to a rule that converts the aggregate numerical score to a category risk level. The rule for this conversion can be based on past experience and judgment of knowledgeable persons and comparison to past risk experience. At 472 the risk level for each KPI category is combined with the risk level for the corresponding business intelligence category to develop a category risk level for the entity. For example, the performance category can be scored according to percentage gain or percentage loss in comparison to one or more prior scores. The performance category also can be weighted according to the potential of that category to create performance risk for the entity.

At 473 a performance risk for the entity is determined from the category risk levels. As previously explained herein, the performance risk can be determined from the category risk levels according to any number of rules and relationships that are established according to the management objectives, the level or conservatism, and other management factors and prerogatives.

If the entity is associated with other entities in a hierarchical relationship, the entity performance risk and the category risk levels for the entity may also be included in the assessment of performance risk for the related entities. At 474 and 476 it is determined whether the entity is in a hierarchical relationship and, if so, whether the related entities are higher or lower in the hierarchy. If there are higher related entities, the entity performance risk analysis may be incorporated into the analysis of those higher entities at 478. If there are lower related entities, the entity risk may be imputed to the performance risk of those lower entities at 480.

Also, it may be desirable to compare the performance risk of two entities that share some common traits or characteristics, whether or not there is a formal relationship between the entities. This can be done by grouping the entities according to common profile codes and then comparing performance risk data at 484.

Referring to FIG. 5, the “Supplier (Parent) Summary” page 210 represents a summary of the structured data, business intelligence data and risk analysis pertaining to a particular supplier. The structured data, business intelligence data and risk analysis are organized according to hierarchal levels of the particular supplier. FIGS. 5-9 illustrate how client 102 can access performance risk assessments for a supplier and its related entities. FIG. 5 illustrates various levels of the performance risk assessment for those entities and data supporting that assessment. That information is further detailed in FIGS. 6-9.

In FIG. 5, supplier 210 is a parent corporation with at least one subsidiary. One of the subsidiaries 230 is a supplier to the client. Supplier subsidiary 230 has at least one manufacturing site 240 that is of interest to client 102. Structured data, business intelligence data and analysis corresponding to the parent corporation are represented as “Parent Summary” 210. Structured data for the parent corporation is shown as “Company (Parent) Information” 210a. Analysis of risk for the parent corporation is shown as “F/O/S Trend Chart” 210b, “F/O/Status” 210c, “Supplier Scatter Plot” 210d, and “Supplier List with F/O/S” 210e. Business Intelligence data for the parent corporation is shown as “Business Intelligence Data” 210f.

Similarly, FIG. 5 also shows structured data, business intelligence data and analysis corresponding to the subsidiary corporation. Those are represented as “Supplier (Subsidiary) Summary” 230. Structured data for the subsidiary corporation is shown as “Company (Subsidiary) Information” 230a. Analysis of risk for the subsidiary corporation is shown as “F/O/S Trend Chart” 230b, “F/O/Status” 230c, “Supplier Scatter Plot” 230d, and “Supplier List with F/O/S” 230e. Business intelligence data for the subsidiary corporation is shown as “Business Intelligence Data” 230f.

Analogous to the structured data, business intelligence data and analysis corresponding to the parent and subsidiary corporations, FIG. 5 also shows structured data, business intelligence data and analysis corresponding to an exemplary manufacturing site of the subsidiary corporation. The data for the manufacturing site is summarized at “Site Summary” 240. Structured data for the subsidiary manufacturing site is shown as “Company (Site) Information” 240a. Analysis of risk for the subsidiary manufacturing site is shown as “Performance Data Ratings” 240b and “Tabular Data” 240b1, and business intelligence data for the subsidiary manufacturing site is shown as “Business Intelligence Data” 240c.

FIG. 5 further details the structured data that is shown as “Company (Parent) Information” 210a, “Company (Subsidiary) Information” 230a and “Company (Site) Information” 240a. These summarize the structured data that is available for the Parent, Subsidiary and Site respectively. The structured data shown as “Company (Parent) Information” 210a, “Company (Subsidiary) Information” 230a and “Company (Site) Information” 240a can be updated according to a time schedule.

“Company (Parent) Information “210a, Company (Subsidiary) Information” 230a, and “Company (Site) Information” 240a each include, respectively, “Company Profile” 210a1, 230a1 and 240a1; “Commodity Information” 210a2, 230a2 and 240a2; “Parts List” 210a4, 230a4 and 240a4; “Turnover” 210a5, 230a5 and 240a5; and “Miscellaneous” 210a3, 230a3 and 240a3. In addition, “Company Information” 230a and 240a also include “Revenue” 230a6 and 240a6. “Company Profile” 210a1, 230a1 and 240a1 represent basic identity information about the parent, subsidiary and site respectively. “Commodity Information” 210a2, 230a2 and 240a2 represent information about the commodities whose pricing/availability have the greatest impact on the parent, subsidiary and site respectively. “Parts List” 210a4, 230a4 and 240a4 include information about the parts that are produced by the parent, subsidiary and site respectively. “Turnover” 210a5, 230a5 and 240a5 describe the inventory turnover rate of the parent, subsidiary and site respectively. “Miscellaneous” 210a3, 230a3 and 240a3 are default locations for parent, subsidiary and site data respectively where such data is not included in another location. “Company Information” 230a and 240a also include “Revenue” 230a6 and 240a6 which contain data about the income of the subsidiary and the site respectively.

In a manner similar to “Company Information” 210a, 230a and 240a, FIG. 5 also illustrates that the “Business Intelligence Data” 210f, 230f and 240c each include a “Link to Answer Questions” 210f1, 230f1 and 240c1 respectively. The “Link to Answer Questions” facilitate tailored information that is provided to the parent, subsidiary and site respectively.

FIG. 5 illustrates the relationship among “Supplier (Parent) Summary” 210, “Supplier (Subsidiary) Summary” 230 and “Site Summary” 240 in terms of performance risk. In FIG. 5, the Site Entity is associated with KPIs that are arranged in groups or bins. The bins of KPIs are organized in categories. Also, the business intelligence data for the site entity is organized in categories that correspond to the categories of KPIs. In the example of FIG. 5, the categories are financial, organizational, and strategic. These are referred to herein as “F/O/S categories” although many other basis of categorizing KPIs and business intelligence data could also be used and are within the scope of the disclosed invention.

At “Performance Data Ratings” 240a, structural data that is KPI indicator data for the Site Entity is applied against a respective rule to produce a risk condition for the KPI. The risk conditions for the KPIs are grouped together in bins and weighted to produce a KPI risk condition for the bin. The KPI risk condition for the bins are weighted and combined to produce a risk condition for the F/O/S category to which the KPIs are assigned. The KPI risk condition for the category is passed to “Site Summary” 240.

In a similar manner, the business intelligence data for the Site Entity is scored at “Business Intelligence Data” 240c. The scores for the business intelligence data within each F/O/S category are then aggregated to produce a score for the F/O/S category. The category score is then applied to a rule and converted to a risk condition for the business intelligence category and the business intelligence condition is passed to the “Site Summary” 240.

At “Site Summary” 240, the risk condition for the KPI category is combined with the risk condition for the corresponding business intelligence category to develop a F/O/S category risk condition for the Site Entity. Both F/O/S category risk conditions are combined to produce a performance risk condition for the Site Entity.

The risk conditions for each of the Site categories are passed from Site Summary 240 to the Supplier Entity “Site List with F/O/S” at 230e. Supplier (Subsidiary) Summary 230 combines the risk conditions for the F/O/S categories at 230e of all the Site Entities that depend from the Supplier to compose risk conditions for respective F/O/S categories at the Supplier level.

In addition, the Supplier Entity 230 may also be associated with KPIs that are arranged in bins and organized in F/O/S categories. The Supplier may also be associated with business intelligence data which is organized in F/O/S categories. In that case, structured data that is KPI indicator data for the Supplier Entity is used to produce risk conditions for KPI categories similar to the manner that risk conditions for KPI categories were developed at the Site Entity level. At 230c, the structured data is applied against a respective KPI rule to produce a risk condition for the KPI. The risk conditions for the KPIs are grouped together in bins and weighted to produce a KPI risk condition for the bin. The KPI risk condition for the bins are weighted and combined to produce a KPI risk condition for the F/O/S category to which the KPIs are assigned. The KPI risk condition is then sent to the Supplier Summary 230.

Also, in a manner similar to the Site Entity, the Supplier Entity may be associated with business intelligence data. The business intelligence data for the Supplier Entity is scored at 230f. The scores for the business intelligence data within each F/O/S category are aggregated to produce a score for the respective F/O/S category. Each F/O/S category score is then converted to a risk condition for the business intelligence F/O/S category. The risk conditions for the Supplier Entity business intelligence F/O/S categories, the KPI F/O/S categories and the Site Level F/O/S categories are combined at Supplier (Subsidiary) Summary 230 to develop Supplier Level F/O/S categories. The F/O/S category risk conditions are combined to produce a performance risk condition for the Supplier Entity.

The risk conditions for each of the F/O/S site categories are passed from Supplier Summary 230 to the “Supplier List with F/O/S” 210e of the Parent Entity. Supplier (Parent) Summary 210 combines the risk conditions for the F/O/S categories of all the Supplier Entities that depend from the Parent to compose risk conditions for respective F/O/S categories at the Parent level.

In addition, the Parent Entity 210 may also be associated with KPIs that are arranged in bins and organized in categories. The Parent may also be associated with business intelligence data which is organized in categories that correspond to the categories of KPIs. In that case, structured data that is KPI indicator data for the Parent entity is used to produce risk conditions for KPI categories similar to the manner that risk conditions for KPI categories were developed at the Supplier Entity level. At 210c, the structured data is applied against a respective KPI rule to produce a risk condition for the KPI. The risk conditions for the KPIs are grouped together in bins and weighted to produce a KPI risk condition for the bin. The KPI risk condition for the bins are weighted and combined to produce a KPI risk condition for the F/O/S category to which the KPIs are assigned. The KPI risk condition is then sent to the Supplier (Parent) Summary 210.

Also, in a manner similar to the Supplier Entity, the Parent Entity may be associated with business intelligence data. The business intelligence data for the Parent Entity is scored at 210f. The scores for the business intelligence data within each F/O/S category are aggregated to produce a score for the respective F/O/S category. Each F/O/S category score is then converted to a risk condition for the business intelligence F/O/S category. The risk conditions for the Parent Entity business intelligence F/O/S categories, the KPI F/O/S categories and the Supplier Level F/O/S categories are combined at Supplier (Parent) Summary 210 to develop Parent Level F/O/S categories. The F/O/S category risk conditions are combined to produce a performance risk condition for the Parent Entity.

Thus, “Supplier (Parent) Summary” 210 provides the company information, and assess performance risk for the parent entity based on structured data, business intelligence data and analysis. It also scores the structured data and business intelligence data according to a rule and assigns a risk condition to the Financial/Operational/Strategic categories of KPIs illustrated at 210c. At 210b, the program maintains a history of past F/O/S risk conditions and constructs a trend list of such conditions. At 210d, the program constructs a scatter plot of the F/O/S scores for all of the parent's subsidiary companies as well as an environmental risk profile.

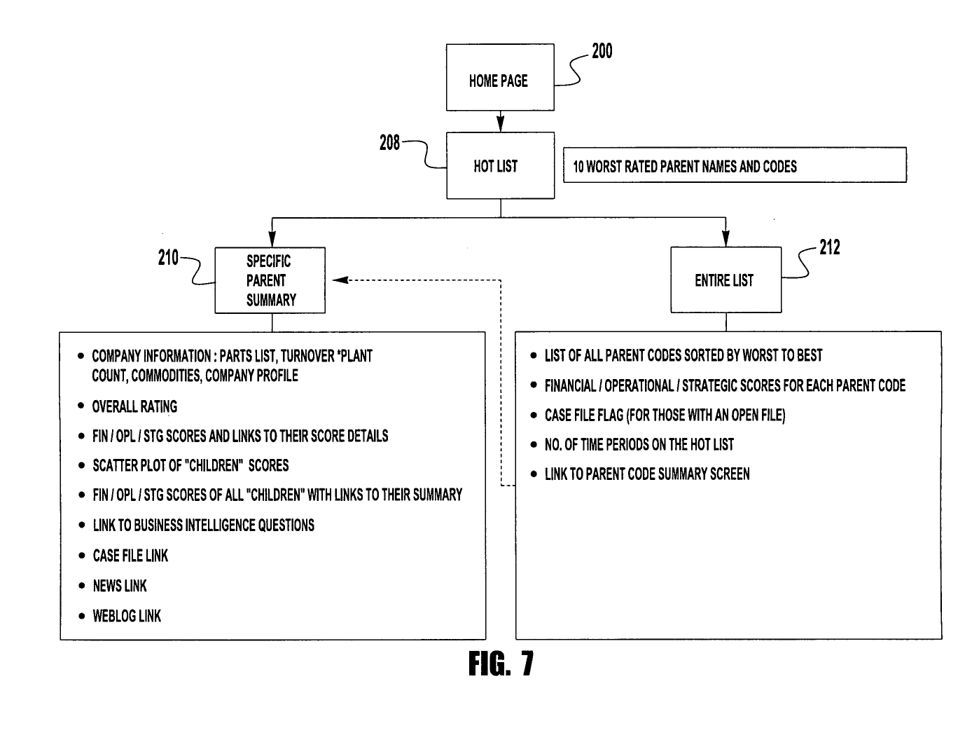

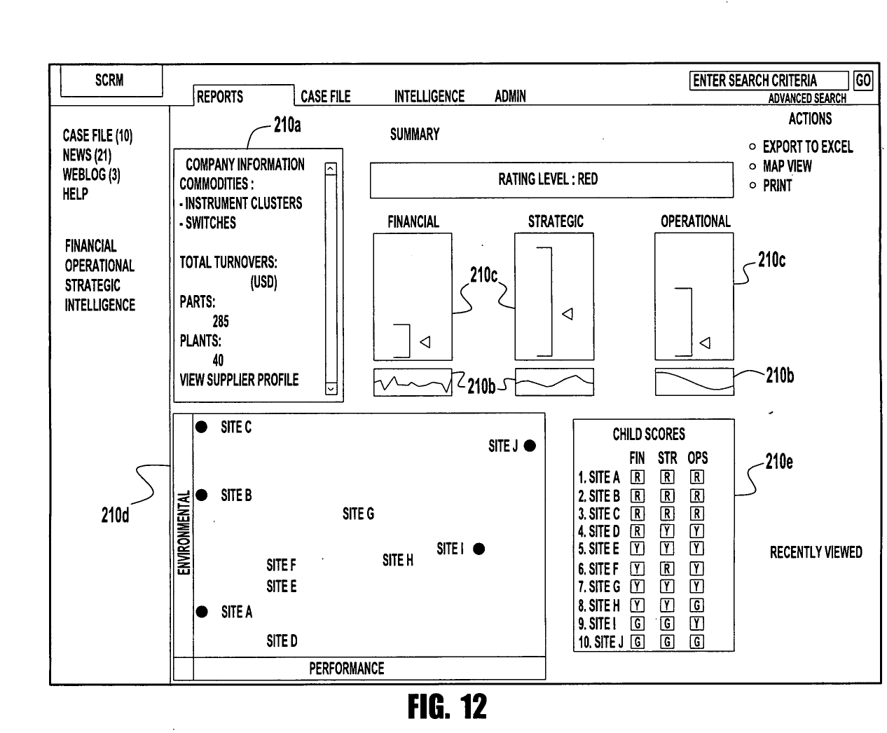

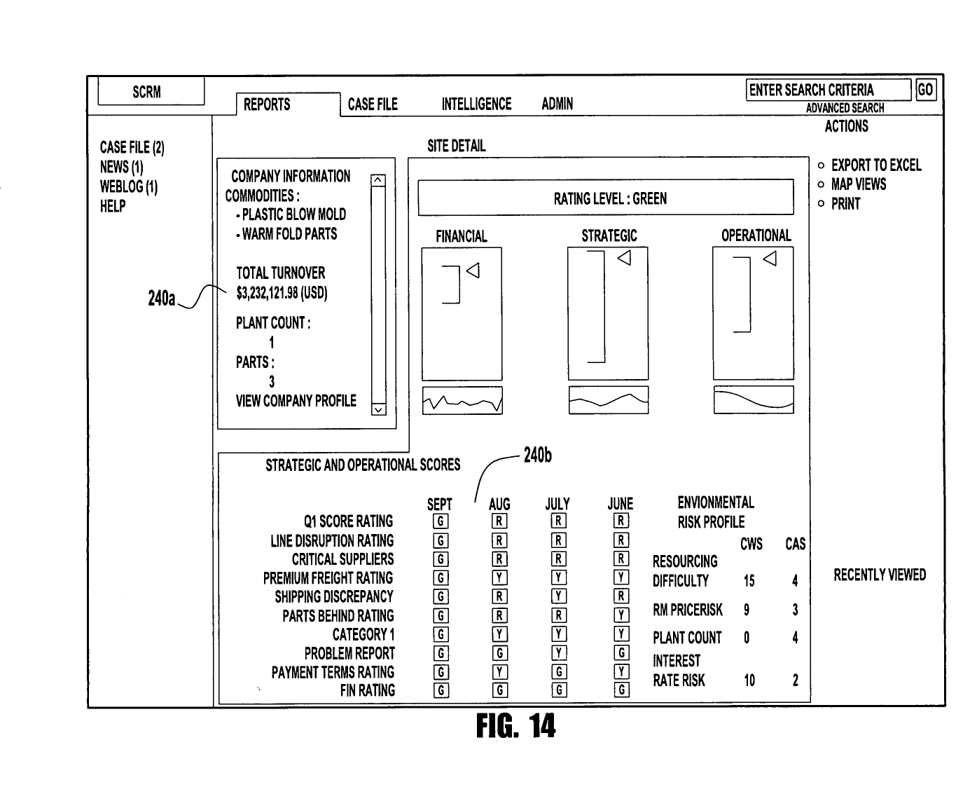

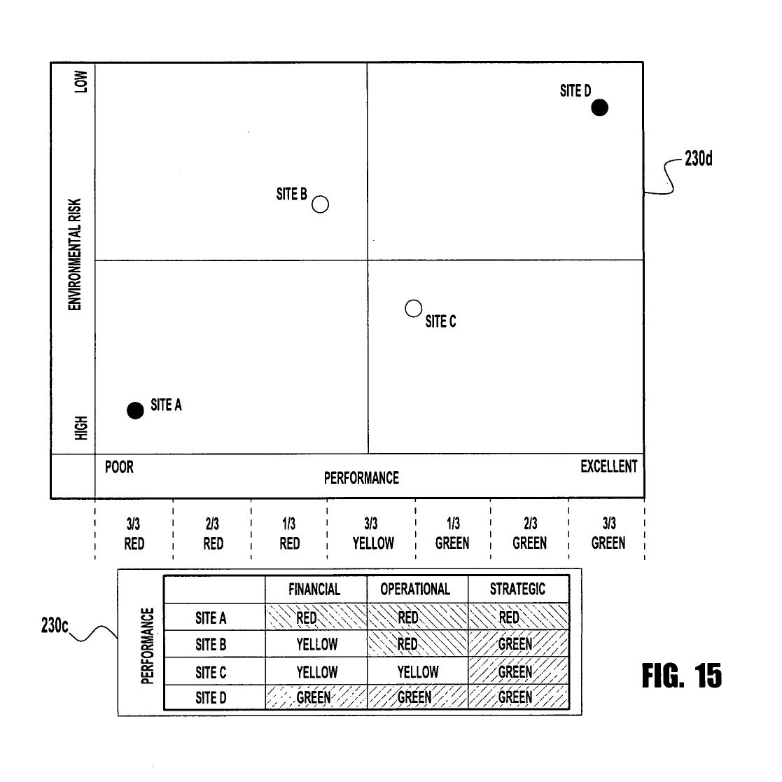

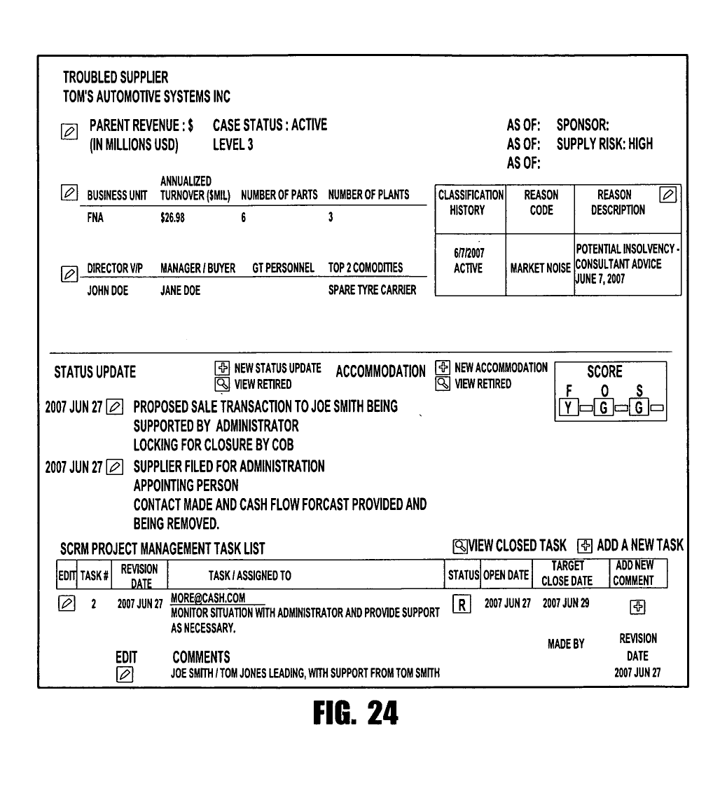

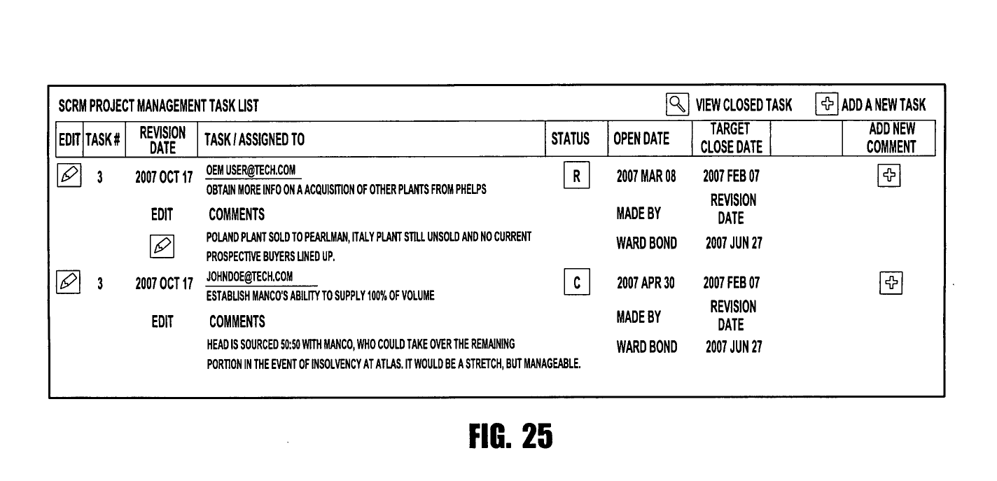

FIG. 5 shows that the servers 106 maintain a “hot list” 208 which is also shown in FIGS. 6 and 7. The “hot list” 208 is a list of predetermined number of suppliers who have been assessed to be the most likely to default in their supply obligation and, therefore, requiring the closest management on the part of the manufacturer. FIG. 7 shows that the “hot list” is compiled from a list 212 of all of the parent entity assessments according to the highest risk rating for financial/operational/strategic scores that are determined for the parent companies. Details for each entity on hot list 208 are also shown at 210 and 212 in FIG. 6. Also in FIG. 6, Supplier (Parent) Summary 212 includes company information and overall rating 210a, F/O/S scores and links 210b and 210c, a scatter plot of subsidiary scores 210d, and F/O/S subsidiary scores 210e. FIG. 12 shows a screen shot that illustrates those views and links. The program also has the capability to link to site detail screen (FIG. 14), case file (FIGS. 24 and 25), news links and web log links.

FIG. 6 further illustrates the search function 202-206 of the program. In response to a client or program administrator command, the computer program can search the entities by name according to a related code or other search basis.

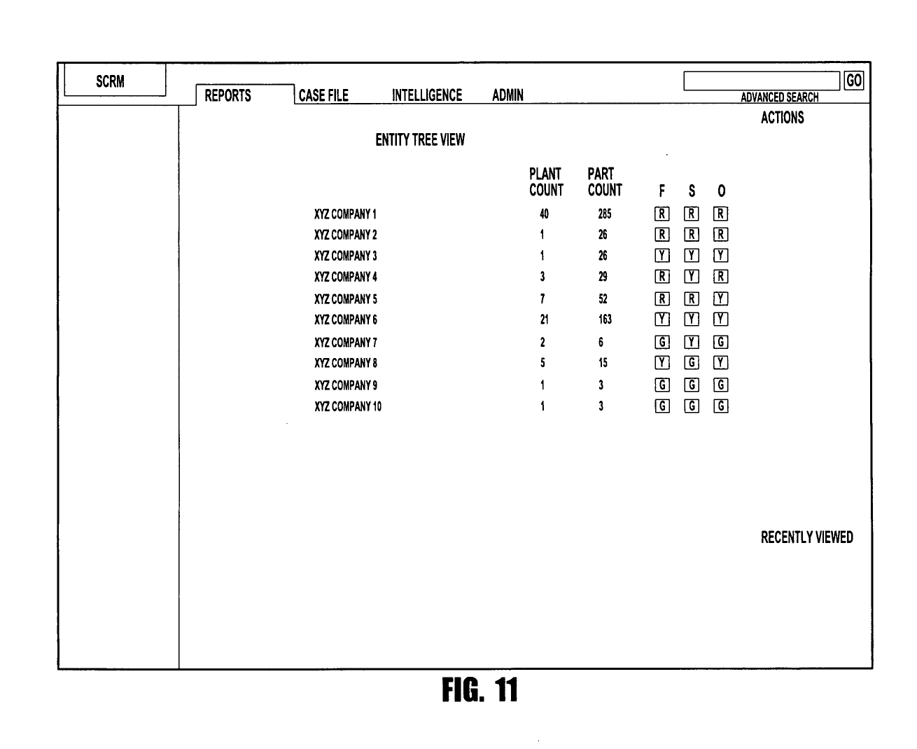

FIG. 7 shows that the information corresponding to the information of FIG. 6 for a particular entity can be obtained at Specific Parent Summary. FIG. 7 shows that, in the preferred embodiment, the information for and entity shown in FIG. 6 can be reached from the entire list of entities. FIGS. 7, 10, 11 and 12 are screen shots of a preferred embodiment which show that this can be accomplished by mouse clicking the name of the entity shown on the screen shot of FIG. 10 or 11 to reach the entity information page shown in the screen shot of FIG. 12.

Also in FIG. 6, home page 200 also maintains a “Recently Viewed” list 214 which is a list of suppliers whom either the client 102 or the program administrator 104 has viewed within a predetermined time. The recently viewed list 214 can be compiled according to the data and time that a company file is opened.

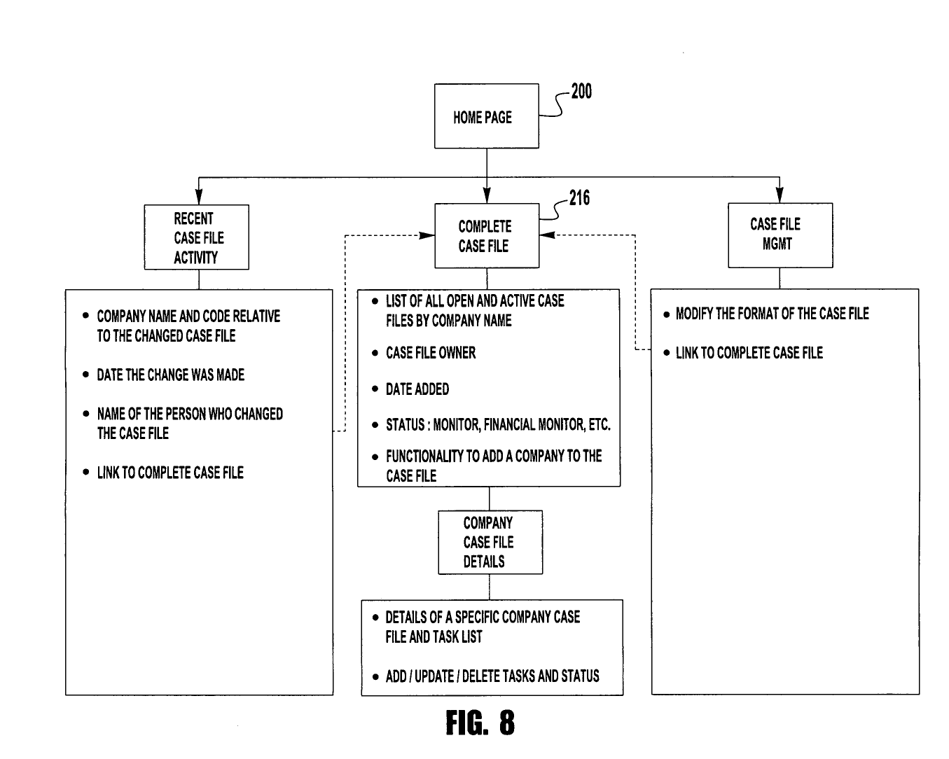

FIGS. 6 and 7 also show that company names can be linked to case files. The details of case files 216 are more particularly shown in FIG. 8. A screen shot of a case file is shown in FIGS. 24 and 25. Case files 216 can be prepared by the client 102 or administrator 104. Case file 216 can include a name and status of the company, a history of actions taken, and a task list. Case files 216 include many other details about the company as selected by the person who prepares the case file. Case file 216 is linked to other pages as shown in FIGS. 6-8 so that it provides a convenient reference to entities whose performance risk warrant special attention. Changes to the case file are monitored and tracked to identify the case file activity and modifications.

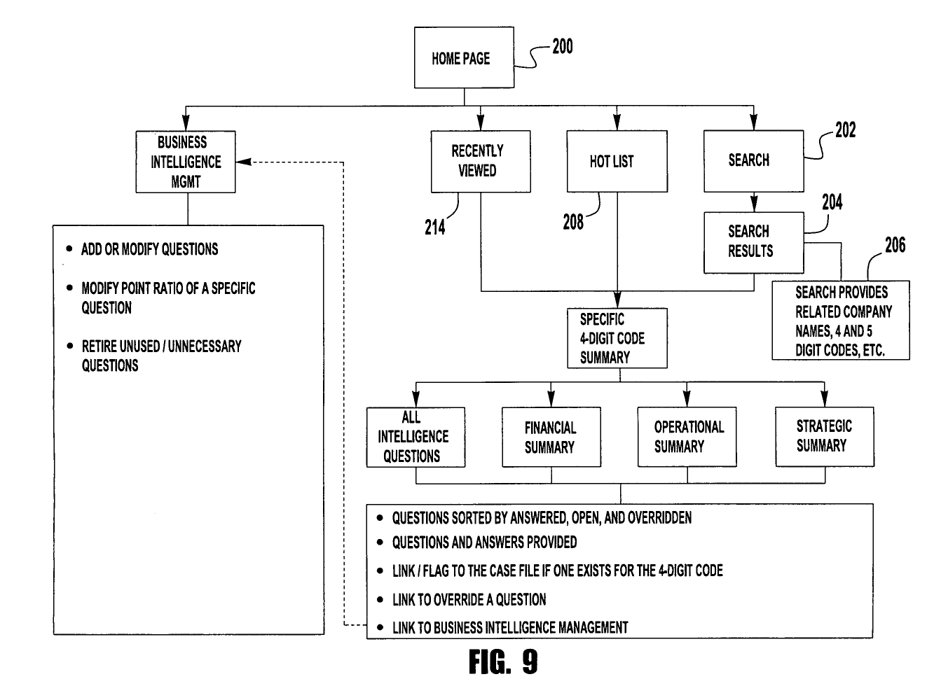

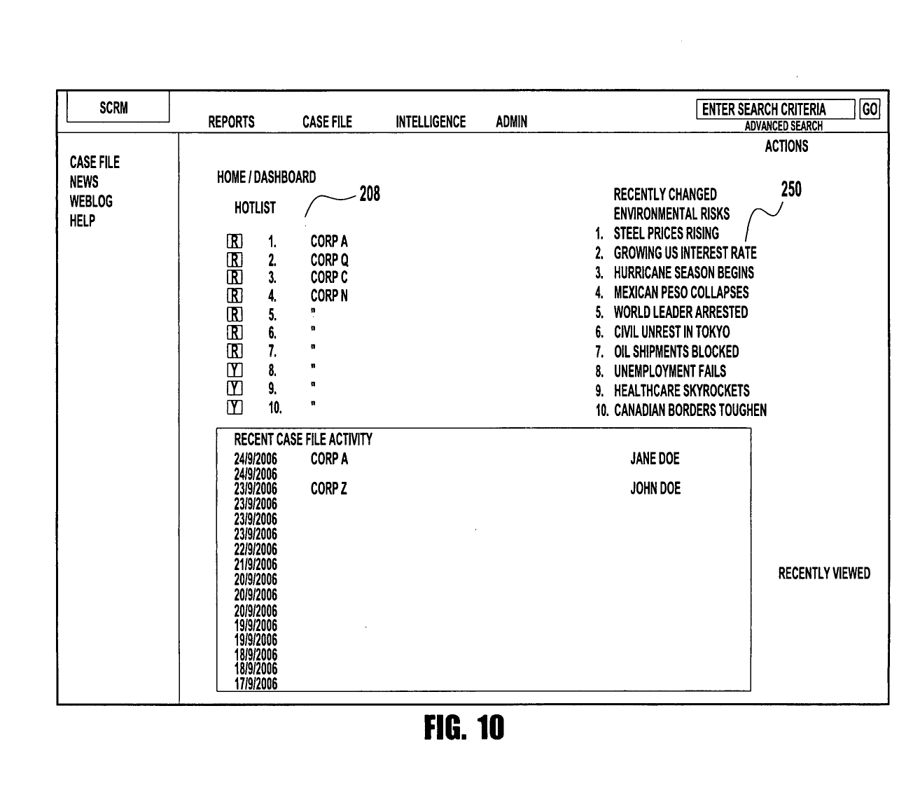

FIG. 9 illustrates that interactive questions that are used to develop business intelligence data. Responses to the business intelligence questions support business intelligence data that is included in categories for financial data, operational data and strategic data. The program manager analyzes this data to add or modify business intelligence questions, to change the weighting for a response to a selected question, or to remove unused or unnecessary questions. FIG. 9 shows business intelligence management features in which questions can asked, sorted, modified, retires and managed in other ways.

FIG. 10 is a screen shot of Home Page 200 which is shown in FIGS. 5-9. The screen shot of FIG. 10 includes the Hot List 208, Recently Viewed Case Files 214, and Recent Case File Activity as discussed in connection with FIGS. 5-8. In addition, the screen shot lists Recently Changed Environmental Risks 250.

FIG. 11 is a screen shot of the Supplier List 210e (FIG. 5) showing a list of all the supplier entities for which a performance risk has been assessed. For each subsidiary, the screen shot also shows the number of sites or plants and the total number of supply parts that those sites or plants supply to the client.

FIG. 12 is a screen shot of Company Information 210a in combination with F/O/S Trend Chart 210b, F/O/S Status 210c, Supplier Scatter Plot 210d, and Supplier List with F/O/S 210e.

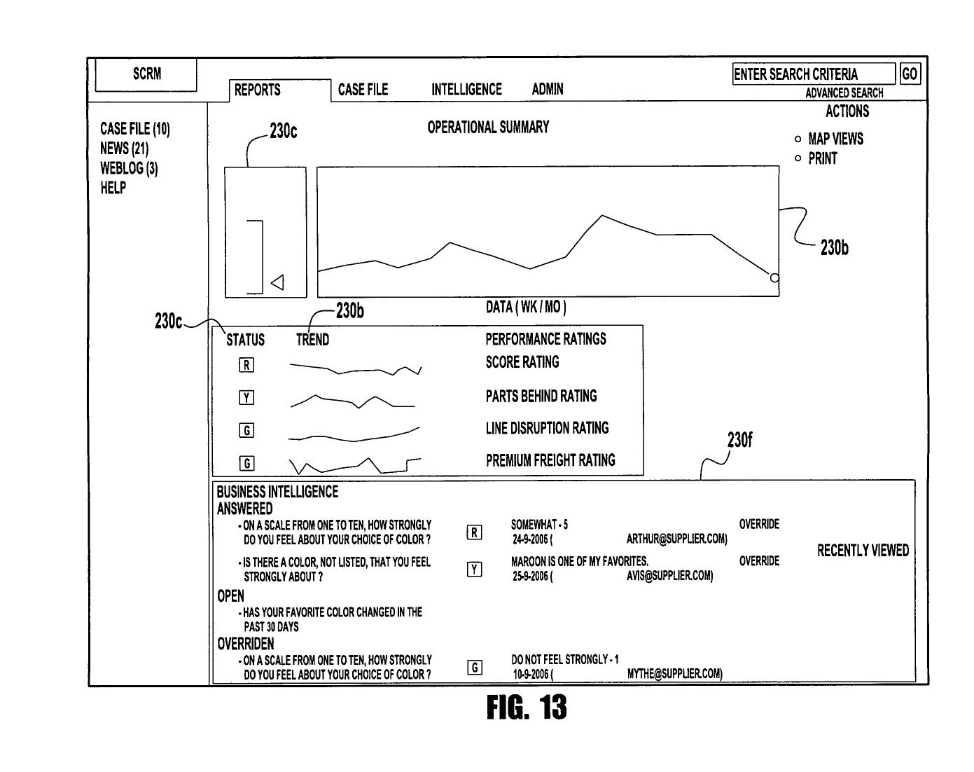

FIG. 13 is a screen shot of the Supplier (Subsidiary) 230 showing F/O/S Trend Chart 230b, F/O/S Status 230c, and Business Intelligence 230f.

FIG. 14 is a screen shot of the Site Summary 240 showing Company Information 240a, and Performance Data Rankings 240b.

FIG. 15 is a screen shot of F/O/S Status 230c and Site Scatter Plot 230d.

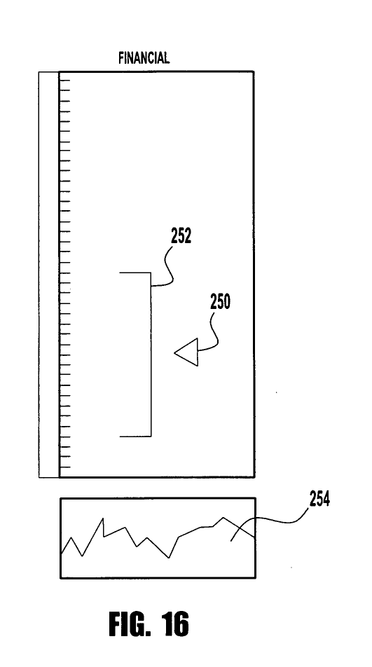

FIG. 16 further explains F/O/S Trend Charts 210b and 230b and F/O/S status 210c and 230c. As more specifically illustrated in connection with FIGS. 12, 13, 14 and 16, the program also monitors the portion of business intelligence data and KPIs on which a risk level is assessed relative to the total potential quantity of business intelligence data and KPI indicator data. This information is evaluated and used as a measure of the completeness or reliability of the risk assessment.

In FIG. 16, Triangle 250 represents the currently assessed level of risk for a respective category. The diagram in FIG. 16 provides context for evaluating the reliability of the assessed level of risk. Specifically, the vertical position of triangle 250 on the scaled column is a graphic representation of the assessed level of risk for the category based on the available structured data and business information data. As risk levels are assessed, triangle 250 is vertically positioned in the column based on the assessed level of risk, taking into account all available structured data and all available business intelligence data. The position of triangle 250 near the top of the column represents a low risk level and the position of triangle 250 near the bottom of the column represents a high level of risk.

Also in FIG. 16, triangle 250 is opposed to a bracket 252. Bracket 252 is graphic representation of possible range of movement of triangle 250 if the balance of the business intelligence data and structured data that has not been used in the assessment became available. The vertical dimension of the bracket is proportional to the quantity of business intelligence data and structured data that has not been used. When the bracket is relatively wide as shown in FIG. 12 for the strategic category, a relatively large proportion of the potentially available data has not been used in the risk assessment. When the bracket is relatively narrow as shown in FIG. 12 for the financial category, a relatively small proportion of the potentially available data has not been used in the risk assessment. Thus, when the bracket 252 is wide and the risk level is based on relatively little data, the confidence level is low. When the bracket 252 is narrow and the risk level is based on a substantial proportion of the available data, the confidence level is high.

The ends of the bracket 252 mark the maximum and minimum positions that the triangle can achieve. Bracket 252 accounts for the data that is already processed to determine the current position of triangle 250 and also accounts for the potential affect of the particular data that has not been used in the assessment. If all of the unused data becomes available and favors a low-risk evaluation, the triangle 250 will move to the top of the bracket. If all of the unused data becomes available and is favorable to a high risk evaluation, the triangle 250 will move to the bottom of the bracket. The triangle 250 cannot move outside the limits of bracket 252.

This assessment of the basis for the risk level assessment provides a confidence level for the performance risk assessment. Line chart 254 identifies the movement of triangle 250 over time as more data becomes available and/or the weighting of the responses to the business intelligence questions or KPIs changes.

FIGS. 17-26 illustrate screen shots of an embodiment of Home Page 200 that is alternative to the embodiment shown in FIGS. 10-16. Similar to the embodiment of FIG. 10, FIG. 17 shows a home page 260 that includes a hot list 262 of ten entities for which the program has caused servers 106 to assess performance risks. In this case, the ten entities are the entities that have demonstrated the fastest rate of decline in performance risk.

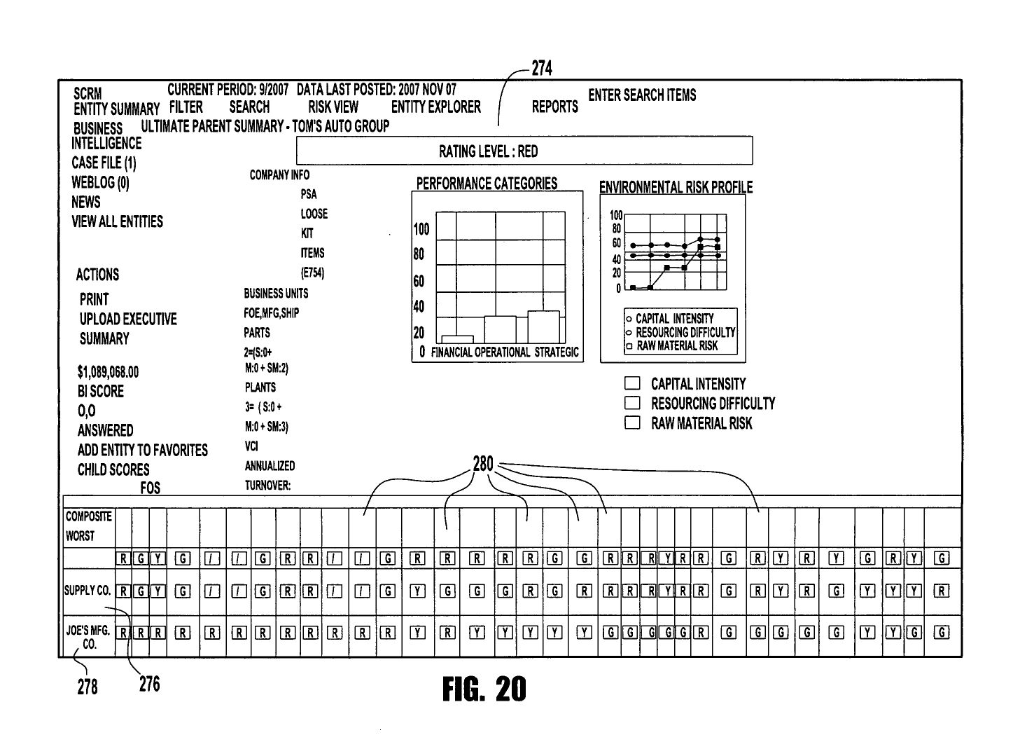

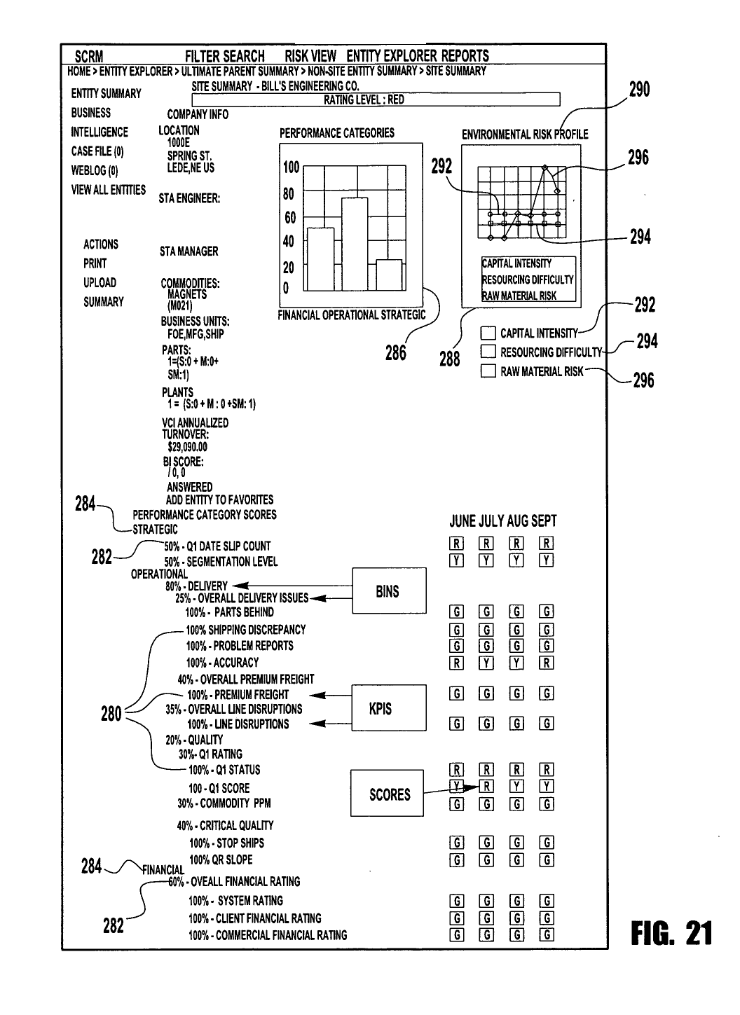

In FIG. 17, hot list 262 shows the risk condition that has been assessed for each financial/operational/strategic category corresponding to each entity. The risk conditions for the respective categories are based on the aggregate scoring for KPI indicators and business intelligence data included in said category as further explained in connection with FIGS. 20-23. Also, FIG. 17 shows changes in the condition levels of the risk categories. An upward directed arrow means that the entity's risk condition increased from the previous assessment period, a downward pointing arrow means that the entity's risk condition decreased from the previous assessment period, and a bar means that there was no material change from the risk condition of the previous assessment period. FIG. 17 also shows page icons that are adjacent to the names of entities for which case files have been developed. A mouse click on the page icon takes the user to the corresponding case file. Examples of a case file are shown in FIGS. 24 and 25.

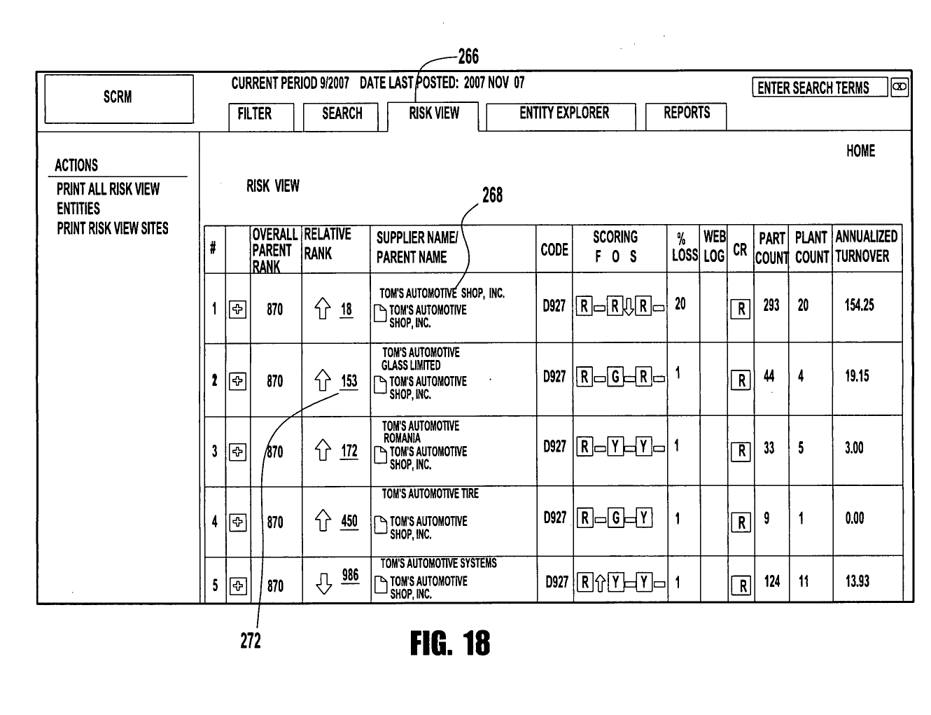

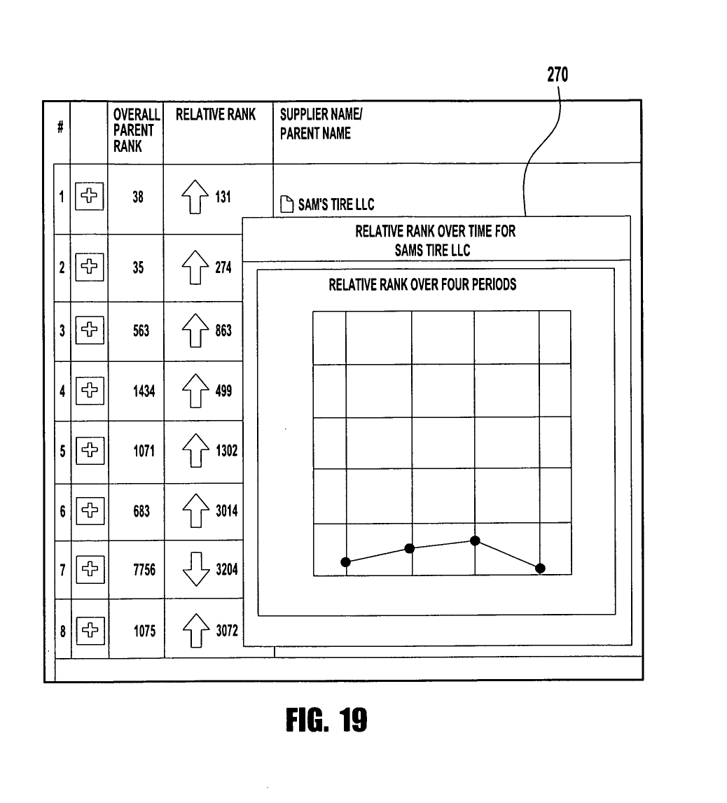

FIGS. 18 and 19 show a list of all the parent entities for which a performance risk has been assessed. FIG. 18 can be opened by mouse clicking the “risk view” tab 266 on home page 260. In list 268, the parent entities are ranked in order of highest performance risk relative to other parent entities. FIG. 19 shows a popup window 270 that graphs the trend for the risk of a particular entity that is listed in FIG. 18 over a given time period. The popup window 270 is opened by holding the pointer over the rank number 272 for the corresponding entity listed in FIG. 18. The trend data is useful to give context to the ranking in FIG. 18.

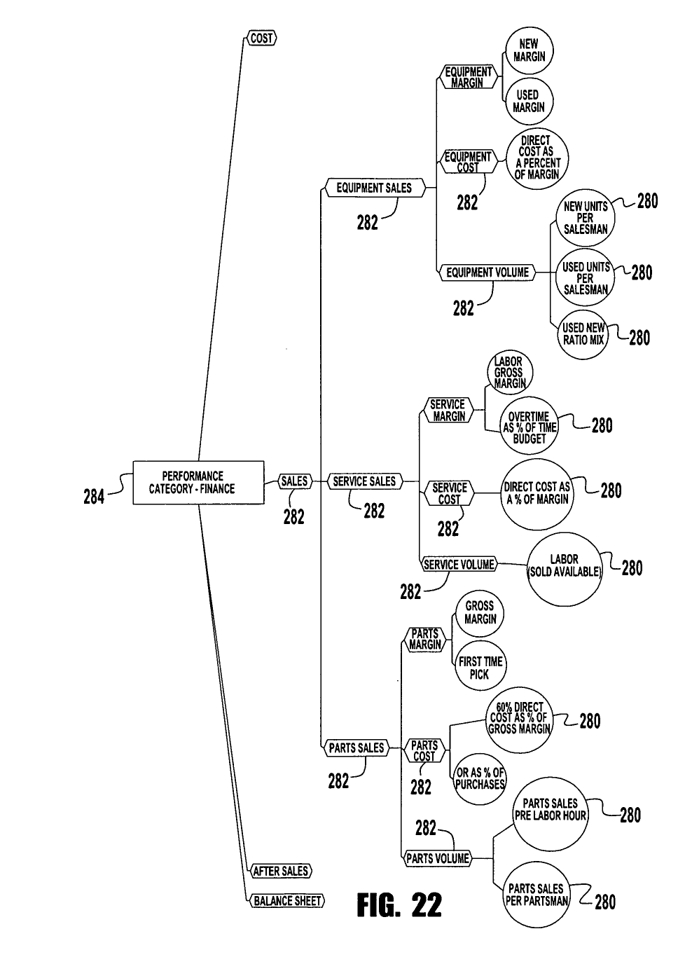

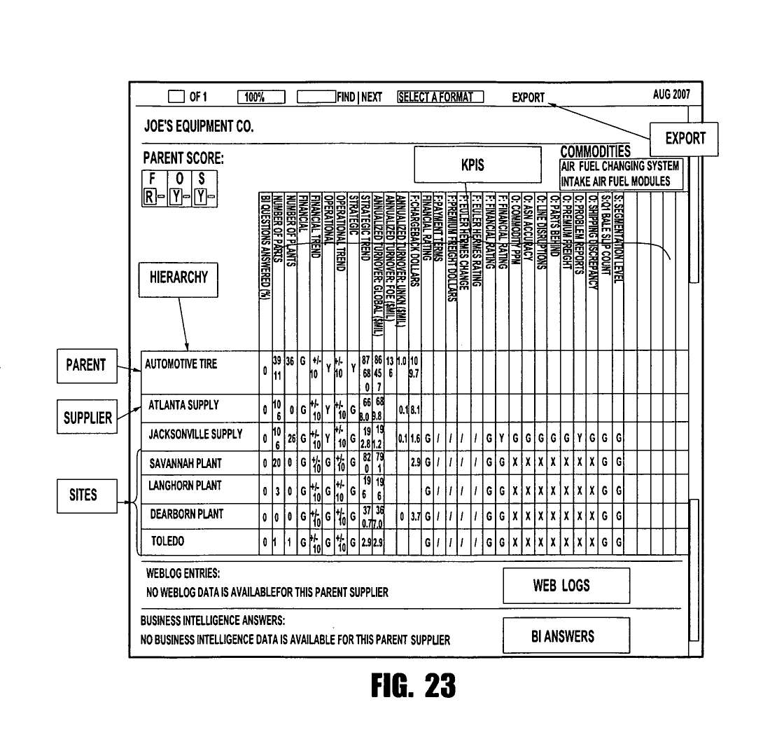

FIG. 20 shows the entity information for one of the parent entities 274 that are shown in FIGS. 17 and 18. The entity information includes the risk condition levels that are assigned to each of the supplier entities 276 and each of the site entities 278 that are included in the parent company. In the hierarchical relationship of the entities, the parent entities 274 correspond to parent summary 210 in FIG. 5, supplier entities 276 correspond to supplier summary 230 and site entities 278 correspond to site summary 240 in FIG. 5. As also shown in the logic chart of FIG. 9, FIG. 20 illustrates that the rating level for the performance risk is based on risk levels in three performance categories: financial, operational and strategic. FIG. 20 also shows the risk condition levels for the financial/operational/strategic categories of supplier entity 276 and site entity 278. The risk levels for each of the categories are aggregated from the risk conditions assigned to KPIs 280 in the corresponding category. The method for assessing the risk conditions assigned to the respective KPIs is explained in further detail in connection with FIGS. 21 and 22.

The disclosed system also allows the client to identify and group entities that share common condition levels or dependencies, even though the entity may not be in the same corporate family. This is useful in comparing and evaluating entities that have similar dependencies but do not make the same products. The grouping can be accomplished by including codes to identify an entity as a member of a group or segment. This code can be included as part of the company profile 210a1, 230a1 and 240a1 in company information 210a, 230a and 240a respectively shown in FIG. 5. The group of entities can be formed according to common identification codes. Other data such as KPIs could also be used to form groups or segments. By grouping the entities in this way, the client can compare entities that share common dependencies and common operating conditions, even though the entities do not necessarily deliver the same goods and services.

The risk conditions for the financial/operational/strategic categories of supplier entity and site entity are developed by combining the risk conditions assigned to respective KPIs 280 in the corresponding category together with risk conditions determined from point scores of business intelligence data in the same category. The point score is applied to a rule for converting the point score to a risk level. For example, assume that the business intelligence score for the financial category is 6. If the scoring rule for the business intelligence in that category equates a score of 6 to a medium risk, the business intelligence component of risk for that entity in that category is “Y”—a medium risk.

The assignment of risk conditions to the KPIs of the categories of an entity group is more specifically described in connection with FIGS. 21 and 22. FIG. 21 shows the site summary page that corresponds to site summary 240 in FIG. 5. FIG. 21 lists various KPIs 280. Each KPI is assigned a risk condition. The risk conditions are determined by applying the rule for the respective KPI to the indicator data that is provided from structured data 112. For example, if the indicator data score for a KPI was two line disruptions and the scoring rule provided that two line disruptions equated to a high risk condition, the KPI would be assigned “R”—a high risk condition.

As further shown in FIG. 21, related KPIs are collected together in subgroups called bins 282. Bins are clusters of related KPIs that may assist in the diagnosis of issues or concerns as determined by the client 102 or the administrator 104. The bins are assigned a weight value relative to other bins in the same category for the KPI in accordance with the likelihood or experience that the KPI will be an accurate predictor of performance risk. In this way, KPIs that are considered to be the most reliable predictors of performance risk can be assigned the greatest importance. The relationship of KPIs 280, bins 282 and categories 284 is further shown in the conceptual illustration of FIG. 22.

Bins 282 are organized under respective financial/operational/strategic categories 284 and the weighted values of bins 282 are aggregated to provide a risk condition for the category. As also shown in FIG. 9, KPI risk conditions in a category are combined with the risk condition for business intelligence data in the same category to produce a risk condition for the category 284. FIG. 21 shows the risk conditions for the financial/operational/strategic categories 284 in a window 286.

The category risk based on KPI and business intelligence risk conditions is determined according to a rule that is fashioned by the client 102 and/or the program administrator 104 or both. As business circumstances may change over time, these rules can be reviewed and modified or amended to reflect the changes and to better model the empirical experience under similar conditions in the past.

As will be apparent those skilled in the art, the information in FIG. 20 can be formatted and presented in various layouts. An example is shown in FIG. 23 wherein the KPIs of the parent, supplier and sites of a corporate family are presented in an alternative format.

FIG. 21 also includes a window 288 that shows an environmental risk profile 290 for the site entity. Environmental risk profile 290 is a graphic representation of selected risk properties that been determined to have particular significance in many applications. Examples of risk properties can be raw materials, resourcing difficulty, technology and parts volume.

In the example of the preferred embodiment, the goods and services of each entity are respectively indexed to a classification system that classifies the goods or services in conformity with generic definitions. In turn, the classes and sub-classes of the classification system are linked to respective risk properties. If the goods and services of an entity are identified, the classification system provides a link between the risk properties and the associated goods and services of an entity. Thus, the goods and services of an entity can be associated with respective risk properties and the risk properties can be aggregated to determine the risk property for the entity.

The example of the embodiment shows three risk properties—capital intensity 292, resourcing difficulty 294, and raw material risk 296. The level of risk associated with a particular risk property can vary over time due to external factors. The disclosed program periodically re-assesses the level of risk associated with each risk property based on changes to the level of risk as assigned by the program administrator 104. As shown in FIG. 21, the risk level for capital intensity 292, resourcing difficulty 294, and raw material risk 296 are saved over time to support a trend chart in window 288 for the risk factors as they apply to the particular entity. This trend chart provides perspective to the risk factors in environmental risk profile 290.

Environmental risk profile 290 has been found to be helpful because a knowledge of capital intensity 292, resourcing difficulty 294, and raw material risk 296 gives the performance risk assessment context and affords guidance to the client 102 is taking appropriate action in response to the assessment of performance risk. For example, if an entity has an unfavorable performance risk assessment, it may be useful for the client to know whether a significant driver in that assessment is capital intensity 292, resourcing difficulty 294, or raw material risk 296. If capital intensity risk 292 is a driver, the client may be able to avoid a business disruption by helping the entity secure additional credit or by transferring the work to another supplier. If resourcing difficulty 294 is a driver in the entity's poor risk assessment, the client may conclude that any replacement supplier may need substantial time to deliver the same product. To avoid a major business disruption, the client may have to make a significant commitment to support the supplier while a permanent solution is found. If raw material risk 296 is a driver in the entity's poor risk assessment, the client may be able to avoid disruption by product design changes that will avoid or reduce the need for the shorted material. Following this model, those skilled in the art will see many other aspects and advantages in applying environmental risk profile 290 wherein the entity is associated with selected risk properties.

Hot list 208 and case file 216 in FIGS. 6-8 are further illustrated in the home page screen shot 260 of FIG. 17. In addition to hot list 262, home page 260 also includes a case files window 264. Case files window 264 lists the ten case files having the highest performance risk. The client 102 is given the capability to construct the contents of case files window 264 by selectively adding files for entities that the client deems of interest. For example, the client could enter case files for those cases for which the client has immediate responsibility or for those case files that supply a particular product to the client.

FIGS. 24 and 25 show a screen shot that is an example of a case file layout. To assist the client in the use of the case files, the case files window 264 includes a task list. FIG. 24 details an example of a project management task list 300 that is shown separately in FIG. 25. This further aids the client in tracking particular files and assuring timely completion of various tasks.

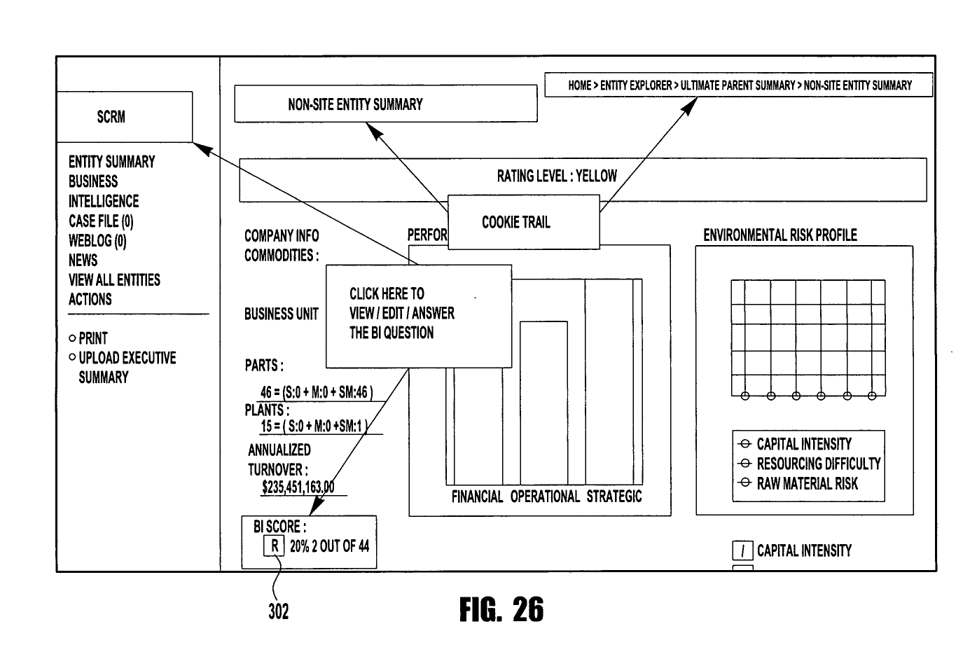

FIG. 26 is a screen shot that illustrates navigational features of the screen shot of FIG. 20. The business intelligence cross-link that is illustrated in FIG. 9 is shown as cross-link 302.

FIG. 27 shows and describes detailed steps for implementing an embodiment of the disclosed method and system as particularly described in connection with FIGS. 2-26. FIG. 27 further details the steps that a client and an administrator could follow to identify dependencies that are associated with the client's suppliers. It also states how factors that reflect the state of such dependencies could be determined. In addition, FIG. 27 describes one work flow statement for establishing indicators that affect those factors and assigning risk condition levels to the factors. Also, FIG. 27 describes evaluating the risk condition levels of the factors to assess the performance risk of the supplier.

While several presently preferred embodiments of the invention have been shown and described herein the presently disclosed invention is not limited thereto but can be otherwise variously embodied within the scope of the following claims.

I claim:

1.) A method for assessing the performance risk of at least one entity, said method comprising the steps of:
identifying dependencies that are associated with said entity;
determining external factors that reflect the state of such dependencies;
establishing indicators that affect said external factors;
assigning condition levels to respective external factors, said condition levels anticipating a risk condition for said external factors based on said established indicators; and
evaluating condition levels assigned to said external factors to assess the performance risk of said entity.

2.) The method of claim 1 for assessing risk of at least one entity, said method comprising the further step of:
weighting said external factors in accordance with the likelihood that said external factors are a reliable predictor of performance risk of said entity.

3.) The method of claim 1 wherein said external factors are grouped into categories, said method assigning condition levels to each of said categories based on the condition levels of said external factors and assessing the performance risk of the entity with respect to the condition levels of said categories.

4.) The method of claim 3 wherein said categories are selected from the group comprising strategic external factors, operational external factors, and financial external factors.

5.) The method of claim 1 wherein said method assesses the risk of more than one entity, said entities being related in a hierarchical association.

6.) The method of claim 1 wherein said method assesses the risk of more than one entity, said entities having at least one common dependency.

7.) The method of claim 1 wherein at least one rule is used to score said indicators and interpret said condition level of said external factor in accordance with said score.

8.) The method of claim 7 wherein said rule is selected form the group comprising:
a. evaluating the frequency that an event occurs;
b. associating ranges of numerical values with warning levels; and
c. establishing warning levels based on the frequency of an event within multiple time periods; and
d. combinations of said rules for evaluating, associating and establishing.

9.) The method of claim 1 further comprising the step of:
establishing a classification system for goods and services wherein said system classifies said goods or services according to at least one characteristic of said goods or services;
relating at least one class of said classification system to a risk property;
associating said risk property with goods or services related to said at least one class;
determining variations over time in the level of risk associated with said risk property; and
assessing changes in the risk property associated with said goods or services of said class.

10.) The method of claim 1 further comprising recording the condition levels assigned to said external factors over time and comparing a condition levels of said external factors with said recorded condition levels.

11.) The method of claim 1 further comprising the steps of:
identifying qualitative questions that are directed to the performance risk of said entity, said qualitative questions requesting a subjective assessment of the economic environment of the entity;
acquiring responses to said qualitative questions;
scoring said responses to said qualitative questions;
evaluating said scores of said responses to said qualitative questions to establish a condition level for said subjective assessment of the economic environment of said entity; and
combining the condition level for said subjective assessment with the condition level of at least one of said external factors to determine the performance risk of the entity.

12.) The method of claim 2 further comprising the steps of:
identifying qualitative questions that are directed to the performance risk of said entity, said qualitative questions requesting a subjective assessment of the economic environment of the entity;
acquiring responses to said qualitative questions;
scoring said responses to said qualitative questions;
evaluating said scores of said responses to said qualitative questions to establish a condition level for said subjective assessment of the economic environment of said entity; and
combining the condition level for said subjective assessment with the condition level of at least one of said weighted external factors from said step of weighting said external factors to determine the performance risk of the entity.

13.) The method of claim 11 wherein scoring step comprises associating a point value with each of said responses.

14.) The method of claim 13 wherein said questions are grouped in at least one category and said responses are scored by combining the point values of responses to questions in the same category to provide a point value score for said responses to said qualitative questions in said category.

15.) A machine-readable storage having stored thereon a computer program for risk management of an entity that has dependencies that affect the performance of said entity, that state of said dependencies being reflected in external factors, said program having a plurality of code sections that are executable by a machine for causing the machine to perform the steps of:
establishing indicators that affect said external factors;
assigning condition levels to respective external factors, said condition levels anticipating a risk condition for said external factors based on said established indicators; and
evaluating condition levels assigned to said external factors to assess the performance risk of said entity.

16.) The machine-readable storage of claim 15 wherein said program further causes the machine to perform the step of
weighting said external factors in accordance with the likelihood that said external factors are a reliable predictor of performance risk of said entity.

17.) The machine-readable storage of claim 15 wherein said external factors are grouped into categories, said program further causing the machine to assign condition levels to each of said categories based on the condition levels of said external factors and assess the performance risk of the entity with respect to the condition levels of said categories.

18.) The machine-readable storage of claim 17 wherein said categories are selected from the group comprising strategic external factors, operational external factors, and financial external factors.

19.) The machine-readable storage of claim 15 wherein said program further causes the machine to assess the risk of more than one entity, said entities being related in a hierarchical association.

20.) The machine-readable storage of claim 19 wherein said program further causes the machine to assess the risk of more than one entity, said entities having at least one common dependency.

21.) The machine-readable storage of claim 15 wherein said program further causes the machine to use at least one rule to score said indicators and interpret said condition level of said external factor in accordance with said score.

22.) The machine-readable storage of claim 21 wherein said rule is selected from the group comprising:
a. evaluating the frequency that an event occurs;
b. associating ranges of numerical values with warning levels; and
c. establishing warning levels based on the frequency of an event within multiple time periods; and
d. combinations of said rules for evaluating, associating and establishing.

23.) The machine-readable storage of claim 15 wherein said program further causes the machine to perform the steps of:
establishing a classification system for goods and services wherein said system classifies said goods or services according to at least one characteristic of said goods or services;
relating at least one class of said classification system to a risk property;
associating said risk property with goods or services related to said at least one class;
determining variations over time in the level of risk associated with said risk property; and
assessing changes in the risk property associated with said goods or services of said class.

24.) The machine-readable storage of claim 15 wherein said program further causes the machine to record the condition levels assigned to said external factors over time and to compare condition levels of said external factors with said recorded condition levels.

25.) The machine-readable storage of claim 15 said program further causing the machine to perform the steps of:
identifying qualitative questions that are directed to the performance risk of said entity, said qualitative questions requesting a subjective assessment of the economic environment of the entity;
acquiring responses to said qualitative questions;
scoring said responses to said qualitative questions;
evaluating said scores of said responses to said qualitative questions to establish a condition level for said subjective assessment of the economic environment of said entity; and
combining the condition level for said subjective assessment with the condition level of at least one of said external factors to determine the performance risk of the entity.

26.) The machine-readable storage of claim 16 wherein said program further causes the machine to perform the steps of:
identifying qualitative questions that are directed to the performance risk of said entity, said qualitative questions requesting a subjective assessment of the economic environment of the entity;
acquiring responses to said qualitative questions;
scoring said responses to said qualitative questions;
evaluating said scores of said responses to said qualitative questions to establish a condition level for said subjective assessment of the economic environment of said entity; and
combining the condition level for said subjective assessment with the condition level of at least one of said weighted external factors from said step of weighting said external factors to determine the performance risk of the entity.

27.) The machine-readable storage of claim 25 wherein said scoring step comprises associating a point value with each of said responses.

28.) The machine-readable storage of claim 27 wherein said questions are grouped in at least one category and said responses are scored by combining the point values of responses to questions in the same category to provide a point value score for said responses to said qualitative questions in said category.

29.) The machine-readable storage of claim 25 wherein said program further causes the machine to integrate the condition levels of said external factors with the condition levels of said subjective assessment of the economic environment to determine the performance risk for the entity.

30.) The machine-readable storage of claim 25 wherein scoring step associates a point value with each of said responses.

31.) The machine-readable storage of claim 16 wherein said program further causes said machine to record the condition levels assigned to said external factors over time and compare condition levels of said external factors with said recorded condition levels.

32.) The machine-readable storage of claim 17 wherein said program further causes said machine to record the condition levels assigned to said categories over time and compare condition levels of said categories with said recorded condition levels.

33.) The machine-readable storage of claim 21 wherein said at least one rule models at least one risk factor.

34.) The machine-readable storage of claim 25 wherein said combining the condition level for said subjective assessment with the condition level of at least one of said external factors to determine the performance risk of the entity includes assessing the completeness of said responses to said qualitative questions.

35.) The machine-readable storage of claim 15 wherein said program further causes the machine to assess the performance risk of more than one entity with at least two of said entities having common dependencies.

36.) The machine-readable storage of claim 35 where said program further causes the machine to compare the performance risk of at least two entities that share at least one common dependency.

37.) The machine-readable storage of claim 17 wherein said condition levels of said external factors are combined and scored according to at least one rule.

38.) The machine-readable storage of claim 36 wherein said program causes the machine to compare the performance risk of at least two entities that share at least one common dependency, said machine also evaluating common external factors corresponding to said entities.

39.) The machine-readable storage of claim 38 wherein said machine also accords the same weight to the same external factor for those entities that have the same dependency.

40.) The machine-readable storage of claim 16 wherein said program further causes the machine to assess the performance risk of more than one entity and wherein at least two of said entities have different dependencies, said machine according different weights to the same external factor for different entities having different dependencies.

41.) The machine-readable storage of claim 46 wherein program causes the machine to compare the performance risk of at least two entities that have no common dependencies, said machine assigning different external factors to a category that is common to each entity.

42.) The machine-readable storage of claim 21 wherein said program further causes the machine to assess the performance risk of more than one entity, said rule defining when the condition level of said external factor for one entity is inherited by another entity.

43.) The machine-readable storage of claim 25 wherein said responses to said qualitative questions are terminated after a given period of time.

44.) The machine-readable storage of claim 25 wherein said qualitative questions are customized with respect to particular entities.
